(19) United States
(12) Patent Application Publication
(10) Pub. No.: US 2026/0028474 A1
(43) Pub. Date: Jan. 29, 2026

(54) DURABLE AND RECYCLABLE THERMOPLASTIC STARCH COMPOSITIONS AND METHODS OF MANUFACTURE THEREOF

(71) Applicant: Erthos Inc., Mississauga (CA)

(72) Inventors: Emmanuel Olusegun Ogunsona, Mississauga (CA); Nima Zarrinbakhsh, Mississauga (CA)

(21) Appl. No.: 19/278,504

(22) Filed: Jul. 23, 2025

Related U.S. Application Data
(60) Provisional application No. 63/674,544, filed on Jul. 23, 2024.
(60) Provisional application No. 63/674,545, filed on Jul. 23, 2024.
(60) Provisional application No. 63/674,548, filed on Jul. 23, 2024.
(60) Provisional application No. 63/674,549, filed on Jul. 23, 2024.

(51) Int. Cl. C08L 3/02

(52) U.S. Cl. CPC C08L 3/02

(57) ABSTRACT

The invention relates to novel starch-based additives and the blends of biodegradable thermoplastic polyesters with the starch-based additive, as well as the method for production thereof. The starch-based additive encompasses starches, acidifiers, alkalizers, plasticizers, and optionally compatibilizers and coupling agents, and fillers. The starch-based additive of the invention could be 100% bio-based and it is melt processable and miscible with biodegradable thermoplastic polyesters. The invention also relates to the novel thermoplastic starch (TPS) compositions, methods of preparation and use thereof. The TPS compositions of the invention exhibit long-term durability of its mechanical properties, long-term processability and recyclability, and high thermal stability. Hence, the elimination of the retrogradation phenomenon in TPS, a drawback well known for TPS, is achieved.

### CROSS REFERENCE TO RELATED APPLICATIONS

This application claims the benefit of U.S. provisional application No. 63/674,544, which was filed on Jul. 23, 2024; U.S. provisional application No. 63/674,545, which was filed on Jul. 23, 2024; U.S. provisional application No. 63/674,548, which was filed on Jul. 23, 2024; and U.S. provisional application No. 63/674,549, which was filed on Jul. 23, 2024, each of which is incorporated herein by reference in its entirety.

### FIELD OF INVENTION

The invention relates to the development of durable, melt-reprocessable, biodegradable and compostable thermoplastic starch compositions for use as an additive in polymer blend compositions for applications such as extruded films, sheets, and profiles, as well as extruded blown films and injection molded rigid parts, within which it possesses enhanced toughness and ductility, and enhanced biodegradability as the targets of its mechanical and biodegradation properties, respectively. In certain embodiments, the invention encompasses compositions comprising starch-based additives that impart flexibility, toughness and elongation when blended with thermoplastic polyesters to produce biodegradable polymer blend compositions for various applications such as injection molding, thermoforming, profile extrusion, extruded films or sheets and compression molding and methods of production thereof.

### BACKGROUND OF THE INVENTION

Biopolymers are a class of polymers derived from natural sources, such as plants, animals, or microorganisms. They are increasingly used in various applications due to their biodegradability and sustainable production processes. However, a common issue with biopolymers is their brittleness. Brittleness refers to a material's tendency to fracture or break without significant deformation when subjected to stress.

Thermoplastic starch (TPS) is a biodegradable and compostable polymer produced from the plasticization of starch as the main component alongside other ingredients such as plasticizers, surfactants, stabilizers and other additives. Starch is a naturally occurring polymer extracted from plants, including but not limited to corn, potatoes, rice, beetroots, ginger, wheat, and cassava just to mention a few.

TPS is prepared by modifying starch through a process that involves heating starch granules in the presence of plasticizers, such as glycerol and water, which are the most commonly utilized plasticizers, causing it to swell and gelatinize. It is well established as an additive for enhancing biodegradability, increasing biobased content and to reduce cost in polymers blends. This versatility makes TPS a compelling alternative to some petroleum-based polymers or as an additive to enhance properties of traditional plastics. However, while showing a lot of promise, TPS also has its share of drawbacks. One significant disadvantage is retrogradation. Retrogradation of TPS typically occurs over time and leads to reduced ductility and elasticity, thereby resulting in a gradual loss of its physical integrity and mechanical properties. Common methods including co-plasticization, the addition of crosslinking agents and the incorporation of other naturally occurring polymers are employed in attempts to inhibit TPS retrogradation. Research towards eliminating this has been explored by many researchers. However, none has been able to fully resolve this problem but only mitigating it by reduction in the retrogradation rate. Therefore, long-term durability or elimination of retrogradation has been a key factor when considering TPS for applications requiring extended use or exposure to environmental stressors.

The innate affinity of TPS for moisture imposes significant limitations on its application. While this characteristic makes TPS suitable for biodegradation where moisture sensitivity is promoted, it also constrains its viability in environments where exposure to moisture could compromise mechanical properties and long term durability. To address this challenge, chitosan and polymers such as PLA and LDPE were combined with TPS to enhance its moisture resistance. Although chitosan contributed to a reduction in the rate of water uptake, it did not completely eliminate it. Conversely, while polymers had proven more effective in improving moisture resistance, they were not 100% bio-based. Managing and mitigating the innate affinity that starch has for moisture absorption is a critical concern in TPS-based product development.

Another limitation of TPS lies in its reprocessability. TPS is typically blended with polymers such as LDPE, PBSA and PBAT, to facilitate reprocessing due to its limitation in its ability to be remelted and reprocessed. However, this reduces its biobased content and renders it in some cases not compostable. For TPS produced with a 100% biobased carbon content and is reprocessable with at least 8 wt. % moisture, retrogradation persisted as a result of moisture loss and was limited to a low processing temperature of 145° C. This limitation was imposed by the initial thermal degradation temperature of TPS, which occurred at 150° C. Additives such as benzoyl peroxide and polycaprolactone (PCL) have demonstrated efficacy in improving the thermal stability of TPS. Though these additives show improvement in the thermal stability, they render the TPS composition partially biobased. These limitations associated with traditional TPS formulations significantly narrow its application scope. Therefore, there is a need for the advancement in TPS technology and the development of a novel TPS that possesses attributes in order to cater to a sustainable material development and widen its application scope. These attributes such as a TPS material with 100% biobased content, reprocessability, high thermal stability and most importantly, resistance to or elimination of retrogradation.

In addition, several strategies are employed to mitigate the brittleness of biopolymers, enhancing their mechanical properties and making them more suitable for various applications. The primary methods include the use of elastomers, plasticizers and blending biopolymers. Many of these solutions have drawbacks, such as lacking compostability, being cost-prohibitive, relying on fossil-based materials, or introducing complexities in processing and compatibility with existing biopolymer systems. However, the novel starch-based additive of this invention can address these issues, offering a more sustainable, cost-effective, and easily integrable alternative.

### SUMMARY OF THE INVENTION

The invention encompasses melt-reprocessable, fully biodegradable and compostable thermoplastic starch (TPS) and/or its derivative compositions which exhibit good elasticity, no retrogradation and having high thermal stability with 100% biobased carbon content, for use in blends with polymers of a wide range of melting temperatures for various plastic applications. In another embodiment, the invention encompasses compositions of novel starch-based additives as well as biodegradable polymer blends comprising biodegradable thermoplastic polyesters and various concentrations of a starch-based additive. In various embodiments, the compositions exhibit enhanced toughness properties. In certain embodiments, the invention utilizes the starch-based additive directly, without the need for any preprocessing or gelatinization step to produce TPS in advance of the production of biodegradable polymer blends.

In accordance with this invention, a process for the production of TPS and the various ingredient combinations is provided. The TPS production can either be performed in one or multi-step processes, which encompasses different order of ingredient addition during these steps to yield different desired properties. The TPS production process extends the range of molecular weights of starch and starch from different sources that can be used and processed at various weight ratios.

In various embodiments, the biodegradable TPS compositions of the invention include a starch or its derivative, starch or modified starch. In certain embodiments, the starch component of the biodegradable composition can include any known starch material, including one or more starch or modified starches and starch derivatives. Preferred starches can include any starch or modified starch that is initially in a native state as a granular solid and which will form a thermoplastic melt by mixing and heating. In certain embodiments, starch includes a natural carbohydrate chain comprising polymerized glucose units. Starches used in compositions of the invention include the following properties: the ability to maintain structure in the presence of many types of other materials, and the ability to be thermally stable and melt into plastic-like materials at a range of temperatures, for example, between about 50 to about 200° C., preferably between about 90 and about 200° C., and in the presence of a wide range of materials and in moist environments and to exhibit high binding strengths.

In other embodiments, the invention encompasses a process to make the starch-based additive, as well as a process of melt-blending the biodegradable thermoplastic polyesters, starch-based additive and optionally other additives including, but not limited to, plasticizers, fillers, coupling agents, processing aids, compatibilizers and initiators are disclosed. In certain embodiments, these ingredients can be blended in specific weight ratios to make tough biodegradable resin compositions with high elongation properties. In certain embodiments, the blend composition development can either be performed in one or multiple-stage processes, which encompasses different ingredient combinations and concentrations.

In certain embodiments, sources of starch may include, for example but not limited to, fruits of all types, starchy plant parts, cereal grains (e.g, corn, waxy corn, wheat, sorghum, rice, and waxy rice, which can also be used in the flour and cracked state), tubers of all types and nature such as potato, roots (tapioca from cassava and manioc), sweet potato, and arrowroot, modified cornstarch, and the pith of the sago palm. In various embodiments, the biodegradable starch-based additive compositions of the invention include a starch or its derivative, starch or modified starch. In certain embodiments, the starch component of the biodegradable starch-based additive composition can include any known starch material, including one or more starch or modified starches and starch derivatives. Preferred starches can include any starch or modified starch that is initially in a native state as a granular solid and which will form a thermoplastic melt by mixing and heating. In certain embodiments, starch includes a natural carbohydrate chain comprising polymerized glucose units. In certain embodiments, starches used in compositions of the invention include the following properties: the ability to maintain structure in the presence of many types of other materials, and the ability to be thermally stable. In certain embodiments, sources of starch may include, for example, but not limited to, tubers of all types and nature such as potato, roots (tapioca from cassava and manioc), sweet potato, and arrowroot, modified corn starch, and the pith of the sago palm.

In various embodiments, the starch present in the compositions of the invention is in an amount from about 20%, 25%, 30%, 35%, 40%, 45%, 50%, 55%, 60%, 65%, 70%, 75%, 80%, 85%, 90% (w/w) based on the total composition.

In certain embodiments, the blend development process extends the range of molecular weights of the different biodegradable thermoplastic polyesters that can be used and melt-blended at various weight ratios.

In various embodiments, the melt-reprocessable, fully biodegradable and compostable starch-based additive shows high thermal stability while having a bio-based carbon content of up to 100%.

In various embodiments, the starch-based additive production can either be performed in one or multi-step processes, which encompasses different orders of ingredient addition during these steps to yield different desired properties.

In certain embodiments, the starch-based additive production process extends the range of molecular weights of starch and starch from different sources that can be used and processed at various weight ratios.

Generally, the invention encompasses a composition comprising the following.

In one embodiment, the raw materials for preparing the biodegradable TPS further include, in parts by mass (w/w) of about 20, 30, 40, 50, 60, 70, 80, 90 of biodegradable starch, modified starch or a combination thereof, from the following such as but not limited to rice starch, potato starch, cornstarch, cassava starch, wheat starch and yam starch.

In various embodiments, the raw materials for preparing the biodegradable TPS further include in parts by mass (w/w) of about 0.2, 0.4, 0.6, 0.8, 1.0, 1.2, 1.4, 1.6, 1.8, 2.0, 5, 10, 15, 20, 25, 30, 35, 40 of one or more acidifiers such as, but not limited to agaric acid, potassium citrate, propane-1,2,3-tricarboxylic acid, aconitic acid, citric acid, tartaric acid, isocitric acid, sodium lactate, trimesic acid and calcium acetate.

In various embodiments, the raw materials for preparing the biodegradable TPS further include, in parts by mass (w/w) of about 5, 10, 15, 20, 25, 30, 35, 40, 45, 50, 60 of one or more plasticizers, including but not limited to water, polyols and plant-based oils. The plant-based oils could be virgin from various sources including but not limited to vegetable, nuts, grains, seeds, etc.: e.g. corn oil, soybean oil, linseed oil, canola oil, peanut oil, palm oil, cashew oil, cottonseed oil, rapeseed oil, olive oil, etc. The plant-based oils could further be modified through different methods including but not limited to epoxidation, carboxylation, hydroxylation and amidation. The plant-based oil could further be modified with long and/or short chain hydrocarbons with functional groups such as but not limited to epoxides, hydroxyls, anhydrides, 2,5-Dimethyl-2,5-di(tert-butylperoxy) hexane and citrates. Polyols are inclusive of the following but not limited to sorbitol, lactitol, maltitol, mannitol, galactitol, xylitol, glycerol, ribitol, arabitol, erythritol and threitol.

In various embodiments, the raw materials for preparing the biodegradable TPS further include, in parts per hundred resin (phr) of about 0.1, 0.2, 0.5, 0.75, 1, 5, 10, 15 of one or more alkalizer with respect to the starch, plasticizer and acidifier, which could be but not limited to calcium carbonate, sodium bicarbonate, potassium citrate, sodium lactate and calcium acetate.

In various embodiments, the starch present in the compositions of the invention is in an amount from about 20% to about 90% (w/w) based on the total composition. In certain embodiments, the starch present in the compositions of the invention is in an amount of about 30% (w/w) based on the total composition. In certain embodiments, the starch present in the compositions of the invention is in an amount of about 40% (w/w) based on the total composition. In certain embodiments, the starch present in the compositions of the invention is in an amount of about 50% (w/w) based on the total composition. In certain embodiments, the starch present in the compositions of the invention is in an amount of about 60% (w/w) based on the total composition In certain embodiments, the starch present in the compositions of the invention is in an amount of about 70% (w/w) based on the total composition. In certain embodiments, the starch present in the compositions of the invention is in an amount of about 80% (w/w) based on the total composition. In certain embodiments, the starch present in the compositions of the invention is in an amount of about 90% (w/w) based on the total composition.

In various embodiments, the modified starch takes up 1, 5, 10, 15, 20, 25, 30, 35, 40, 45, 50, 55, 60 parts by mass. In one embodiment, the raw materials for preparing the biodegradable.

In certain embodiments, TPS may further include, in parts by mass (w/w) of about 0, 2, 4, 6, 8, 10, 12, 14, 16, 18, 20, 25, 30, 35, 40, 45, 46, 47, 48 up to 50 of fillers which encompasses both inorganic and biomass fillers and a combination thereof.

In certain embodiments, the inorganic fillers are, but not limited to, wollastonite, mica, clay, talc, silicon dioxide, calcium carbonate, glass fiber, aluminum and magnesium silicates, zirconium oxide, iron oxides, glass fibers and bids, sepiolite, and gypsum.

In certain embodiments, the biomass may further include, but not limited to, vinasse, vinegar residues, wood fiber, virgin starch, agricultural cellulosic matter from straw, stalk, shive, hurd, bast, leaf, seed, fruit, and perennial grass, all in a non-continuous non-woven form including chopped pieces, particulates, dust or flour.

In one embodiment, the raw materials for preparing the biodegradable TPS may further include, in parts by mass (w/w) of about 0, 0.1, 0.2, 0.5, 0.75, 1, 5, 10, 15 up to 20 of one or more compatibilizer which could be but not limited to organic acids such as adipic acid, azelaic acid, brassylic acid, dodecanedioic acid, glutaric acid, succinic acid, pimelic acid, suberic acid, citric acid, sebacic acid, undecanedioic acid, lactic acid, tetradecanedioic acid, agaric acid, propane-1,2,3-tricarboxylic acid, aconitic acid, tartaric acid, isocitric acid, trimesic acid, pentadecanedioic acid, oxalic acid, malonic acid, glutamic acid, aspartic acid, itaconic acid, glucaric acid and hexadecanedioic acid.

In various embodiments, the composition exhibits a 100% biobased carbon content.

In one embodiment, the thermogravimetric analysis (TGA) of the biodegradable TPS composition exhibits a weight loss of 9.7% at a temperature of 200° C.

In one embodiment, the thermogravimetric analysis (TGA) of the biodegradable TPS composition exhibits a weight loss of 10.9% at a temperature of 200° C.

In one embodiment, the thermogravimetric analysis (TGA) of the biodegradable TPS composition exhibits a weight loss of 12.7% at a temperature of 200° C.

In one embodiment, the thermogravimetric analysis (TGA) of the biodegradable TPS composition exhibits an onset temperature of 125° C.

In another embodiment, the thermogravimetric analysis (TGA) of the biodegradable TPS composition exhibits an onset temperature of 140° C.

In other embodiments, the invention encompasses a method for preparing the biodegradable TPS composition comprising the following steps:

In certain embodiments, a premix of all the ingredients and optionally fillers are compounded by means of a batch mixer or extruder for a prescribed time period at temperatures higher than ambient temperatures to make the final TPS.

In certain embodiments, a premix of all the ingredients and optionally fillers are compounded all together by means of a batch mixer or extruder for a prescribed time period at temperatures higher than ambient temperatures to make the final TPS.

In other embodiments, the starch is premixed with one or more of each of the following: acidifier, plasticizer, compatibilizer, alkalizer and optionally fillers, and then compounded for a prescribed time period at temperatures higher than ambient temperatures to make the final TPS.

In other embodiments, the starch is premixed with one of the acidifier, plasticizer, compatibilizer, alkalizer and optionally fillers, and then compounded for a prescribed time period at temperatures higher than ambient temperatures using an extruder while a second plasticizer is infused downstream before the final TPS is extruded.

In other embodiments, the starch is premixed with a specific acidifier, plasticizer, compatibilizer and alkalizer and then compounded for a prescribed time period at temperatures higher than ambient temperatures using an extruder while in a second extruder in tandem, a premix of starch with another specific acidifier, plasticizer, compatibilizer and alkalizer is compounded for a prescribed time period at temperatures higher than ambient temperatures. Both compounded TPS in each extruder are mixed downstream to produce the final TPS.

In certain embodiments, the method includes preparing biodegradable flexible film parts or biodegradable rigid parts from the biodegradable composition via conventional polymer processing techniques including, but not limited to, compression molding, hot press, injection molding, blow molding, cast film extrusion and thermoforming.

### Starch-Based Additive Composition

In certain embodiments, the invention further encompasses raw materials for preparing a biodegradable starch-based additive which include, in parts by mass (w/w) of about 20, 25, 30, 35, 40, 45, 50, 55, 60, 65, 70, 75, 80, 85, or 90 of biodegradable starch, modified starch or a combination thereof, from the following such as but not limited to rice starch, potato starch, corn starch, cassava starch, wheat starch and yam starch.

In certain embodiments, the raw materials for preparing the biodegradable starch-based additive further include in parts by mass (w/w) of about 0.2, 0.4, 0.6, 0.8, 1.0, 1.2, 1.4, 1.6, 1.8, 2.0 up to 40 of one or more acidifiers such as, but not limited to agaric acid, potassium citrate, propane-1,2,3-tricarboxylic acid, aconitic acid, citric acid, tartaric acid, isocitric acid, sodium lactate, trimesic acid and calcium acetate.

In certain embodiments, the raw materials for preparing the biodegradable starch-based additive further include, in parts by mass (w/w) of about 5, 10, 15, 20, 25, 30, 35, 40, 45, 50, 60 of one or more plasticizers, including but not limited to water, polyols and plant-based oils. The plant-based oils could be virgin from various sources including but not limited to vegetable, nuts, grains, seeds, etc., e.g. corn oil, soybean oil, linseed oil, canola oil, peanut oil, palm oil, cashew oil, cottonseed oil, rapeseed oil, and olive oil. The plant-based oils could further be modified through different methods including but not limited to epoxidation, carboxylation, hydroxylation and amidation. The plant-based oil could further be modified with long and/or short chain hydrocarbons with functional groups such as but not limited to epoxides, hydroxyls, anhydrides, 2,5-Dimethyl-2,5-di(tert-butylperoxy) hexane and citrates. Polyols are inclusive of the following but not limited to sorbitol, lactitol, maltitol, mannitol, galactitol, xylitol, glycerol, ribitol, arabitol, erythritol and threitol.

In one embodiment, the raw materials for preparing the biodegradable starch-based additive further include, in parts per hundred resin (phr) of about 0.1, 0.2, 0.5, 0.75, 1, 5, 10, 15 of one or more alkalizer with respect to the starch, plasticizer and acidifier, which could be but not limited to calcium carbonate, sodium bicarbonate, potassium citrate, sodium lactate and calcium acetate.

In one embodiment, the raw materials for preparing the biodegradable starch-based additive may further include, in parts by mass (w/w) of about 0, 2, 4, 6, 8, 10, 12, 14, 16, 18, 20, 25, 30, 35, 40, 45, 46, 47, 48 up to 50 of fillers which encompasses both inorganic and biomass fillers and a combination thereof.

In certain embodiments, the inorganic fillers are, but not limited to, wollastonite, mica, clay, talc, silicon dioxide, calcium carbonate, glass fiber, aluminum and magnesium silicates, zirconium oxide, iron oxides, glass fibers and bids, sepiolite, and gypsum.

In certain embodiments, the biomass includes, but not limited to, vinasse, vinegar residues, wood fiber, virgin starch, agricultural cellulosic matter from straw, stalk, shive, hurd, bast, leaf, seed, fruit, and perennial grass, all in a non-continuous non-woven form including chopped pieces, particulates, dust or flour.

In one embodiment, the raw materials for preparing the biodegradable starch-based additive may further include, in parts by mass (w/w) of about 0, 0.1, 0.2, 0.5, 0.75, 1, 5, 10, 15, 20 of one or more compatibilizer which can include organic acids such as adipic acid, azelaic acid, brassylic acid, dodecanedioic acid, glutaric acid, succinic acid, pimelic acid, suberic acid, citric acid, sebacic acid, undecanedioic acid, lactic acid, tetradecanedioic acid, agaric acid, propane-1,2,3-tricarboxylic acid, aconitic acid, tartaric acid, isocitric acid, trimesic acid, pentadecanedioic acid, oxalic acid, malonic acid, glutamic acid, aspartic acid, itaconic acid, glucaric acid and hexadecanedioic acid.

In one embodiment, the modified starch takes up 1, 5, 10, 15, 20, 25, 30, 35, 40, 45, 50, 55, or 60 parts by mass (w/w).

In certain embodiments, the starch-based additive composition exhibits a 100% bio-based carbon content.

In other embodiments, the invention encompasses a method for preparing the biodegradable starch-based additive composition comprising the following steps:

Mixing all the ingredients and optionally other additives all together by means of a batch or a continuous mixer for a prescribed time period at room temperature to make the final starch-based additive.

In other embodiments, the starch is premixed with one of each of the following: acidifier, plasticizer, compatibilizer, alkalizer and optionally other additives, and then mixed for a prescribed time period at room temperature to make the final starch-based additive.

In other embodiments, the starch is premixed with one or more of each of the following: acidifier, plasticizer, compatibilizer, alkalizer and optionally other additives, and then mixed for a prescribed time period at room temperature to make the final starch-based additive.

The order of mixing the ingredients is not limited to the above-mentioned embodiments and could include any other possible embodiments, equipment or processing parameters.

In certain embodiments, the biodegradable TPS compositions or the biodegradable starch-based additive compositions of the invention can be used in blends with other biodegradable polymers to produce biodegradable polymer blend compositions in various embodiments from packaging and single use products to durable products and in a wide range of applications, from packaging to medical, consumer products, and many more.

In yet other embodiments, the biodegradable TPS compositions or the biodegradable starch-based additive compositions of the invention can be used in blends with traditional polymers to produce partially-biobased polymer blend compositions in various embodiments from packaging and single use products to durable products and in a wide range of applications, from packaging to medical, consumer products, and many more.

In certain embodiments, the biodegradable polymer blend compositions or the partially-biobased polymer blend compositions of the invention can be produced using mixing and melt-compounding equipment with adjustable and controllable temperatures, mixing speeds and barrel pressures. During production, the barrel pressure could be set to atmospheric pressure or put under vacuum. These melt-compounding equipment could be but not limited to, such as a single or twin screw extruder or a batch kneader. The resulting product may be formed into films or sheets using conventional cast extrusion, blown film extrusion or compression molding techniques. The resulting product may further be formed into rigid articles using conventional injection molding machines. The extrusion, injection or compression temperature is typically within the range used in the melt-processing and compounding of the TPS ingredients.

The biodegradable polymer blend compositions include the biodegradable TPS or the starch-based additive of this invention in parts by mass (w/w) of about 5 to 95%. In various embodiments, the parts by mass (w/w) of the biodegradable TPS or the starch-based additive in the biodegradable polymer blend composition are about 5, 10, 20, 30, 40, 50, 60, 70, 80, 90 and 95 wt. %.

The biodegradable polymer blend composition further includes at least one biodegradable thermoplastic polyester. In various embodiments, the biodegradable thermoplastic polyesters include but are not limited to polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT) and polyhydroxyalkanoates (PHAs).

The parts by mass (w/w) of the biodegradable thermoplastic polyesters in the biodegradable resin composition are about 5 to 95 wt. %. In various embodiments, the parts by mass (w/w) of biodegradable thermoplastic polyesters in the resin are about 5, 10, 20, 30, 40, 50, 60, 70, 80, 90 and 95 wt. %.

The partially-biobased polymer blend compositions include the biodegradable TPS or the starch-based additive of this invention in parts by mass (w/w) of about 5 to 95%. In various embodiments, the parts by mass (w/w) of the biodegradable TPS or the starch-based additive in the partially-biobased polymer blend composition are about 5, 10, 20, 30, 40, 50, 60, 70, 80, 90 and 95 wt. %.

The partially-biobased polymer blend composition further includes at least one thermoplastic polyolefin. In various embodiments, the polyolefins include but are not limited to polypropylene (PP), homo-polypropylene (homo-PP), co-polypropylene (co-PP), polyethylene (PE), low density polyethylene (LDPE), linear low density polyethylene (LLDPE), high density polypropylene (HDPE), ultra-high-molecular-weight polyethylene (UHMWPE), high-modulus polyethylene (HMPE), thermoplastic elastomers (TPE), ethylene-propylene copolymer (EPC or EPM), polyisobutylene (PIB), polybutene (PB), polyethylene-co-vinyl acetate (EVA), and ethylene-propylene-diene monomer (EPDM).

The parts by mass (w/w) of the polyolefin in the partially-biobased resin composition are about 5 to 95 wt. %. In various embodiments, the parts by mass (w/w) of polyolefins in the resin are about 5, 10, 20, 30, 40, 50, 60, 70, 80, 90 and 95 wt. %.

In some embodiments, the biodegradable blend composition further includes in parts by mass (w/w) of about 0 to about 40 of at least one plasticizer. In various embodiments, the amount of the plasticizer is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In various embodiments, the plasticizers of the biodegradable resin include, but are not limited to, plant-based oils obtained from sources such as vegetables, nuts, grains, seeds, etc. Examples of such oils include, but are not limited to, corn oil, soybean oil, and glycerol. These plant-based oils can be used either in their virgin or modified form (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In another embodiment, the biodegradable blend composition further includes in parts by mass (w/w) of about 0 to about 10 of at least one bio-based organic acid compatibilizer including, but not limited to lactic acid, formic acid, stearic acid, tannic acid, malic acid, citric acid, aspartic acid, ascorbic acid, acetic acid, tartaric acid. In various embodiments, the amount of the organic acid compatibilizer is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable blend composition further includes, in parts by mass (w/w) of about 0 to about 10 of one or more coupling agents which encompasses both short and long-chain hydrocarbons with functional groups such as but not limited to epoxides, hydroxyls, anhydrides and citrates. In various embodiments, the amount of the coupling agent is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In certain embodiments, the biodegradable blend composition further includes, in parts by mass (w/w) of about 0 to about 40 of one or more fillers which encompasses both inorganic and biomass fillers or a combination thereof. In certain embodiments, the amount of the inorganic and/or biomass fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In certain embodiments, the inorganic fillers are, but not limited to, wollastonite, mica, clay, calcium carbonate, glass fiber, talc, aluminum silicate, silicon dioxide, zirconium oxide, sepiolite, gypsum, and other minerals or a combination thereof.

In certain embodiments, the biomass includes, but not limited to, distillers' grains vinasse, vinegar residues, wood fiber, virgin starch, modified starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the biodegradable blend composition could further include compatibilizers, chain extenders, peroxides, initiators, pigments, cross-linkers, or a combination thereof in a weight ratio ranging from about 0 to about 10 wt. %. In certain embodiments, the amount of one or more compatibilizers, chain extenders, peroxides, initiators, pigments, cross-linkers, or a combination thereof is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

The aforementioned ingredients may be processed together in various scenarios. In one embodiment, all ingredients are premixed and melt-processed together.

In another embodiment, the biodegradable thermoplastic polyester(s) is melted first, and then the biodegradable TPS or the starch-based additive is added to the system before the addition of other additives.

In another embodiment, the biodegradable TPS or the starch-based additive is first charged into the processing equipment, and then the biodegradable thermoplastic polyester(s) are added to the system before other additives.

In another embodiment, the biodegradable thermoplastic polyester(s) is melted first, and then the other additives are added to the system before the addition of the starch-based additive or the biodegradable TPS.

In yet another embodiment, the biodegradable TPS or the starch-based additive is added first, and then the other additives are charged to the system before the addition of biodegradable thermoplastic polyester(s).

The order of introducing the ingredients to the system is not limited to these embodiments and may include any other possible embodiments and combinations.

In one embodiment, the blending of the aforementioned ingredients may be achieved using mixing and melt-compounding equipment with adjustable and controllable temperatures, such as a single or twin screw extruder, or a batch mixer.

In a batch mixer, the processing temperature profile may range from 50 to 250° C., and the processing time may be between 1 to 60 minutes.

Alternatively, in embodiments where single or twin screw extrusion is employed, the temperature profile may range from 50 to 250° C., and the screw speed may range from 20 to 500 rpm. It should be noted that the processing conditions provided herein are not limiting and may vary based on other conditions such as ingredient amounts and ratios and the type of processing equipment.

In one embodiment, 20 wt. % of starch-based additive improved the elongation at break of the biodegradable thermoplastic polyester from 2.6 to 6.9%.

In one embodiment, 20 wt. % of starch-based additive improved the elongation at break of the biodegradable thermoplastic polyester from 230 to 322%.

In one embodiment, 40 wt. % of starch-based additive improved the elongation at break of the biodegradable thermoplastic polyester from 414 to 786%.

In one embodiment, 20 wt. % of starch-based additive improved the notched Izod impact strength of the biodegradable thermoplastic polyester from 37 to 76 J/m.

In one embodiment, 40 wt. % of starch-based additive improved the notched Izod impact strength of the biodegradable thermoplastic polyester from 97 to 330 J/m.

In one embodiment the stress at yield and break dropped slightly from 8.4 to 7 and 22.1 to 19.5 MPa, respectively, after blending the biodegradable thermoplastic polyester with 20 wt. % starch-based additive.

In various embodiments, the bio-based carbon content of the final blend was 100%.

In certain embodiments, the blend composition exhibits 10%, 20%, 30%, 40%, 50%. 60%, 70%, 80%, or 90% disintegration completion within about 180 to about 365 days at ambient temperature.

In certain embodiments, the blend composition exhibits 10%, 20%, 30%, 40%, 50%. 60%, 70%, 80%, or 90% disintegration completion within about 180 to about 365 days in soil at ambient temperature.

In certain embodiments, the blend composition exhibits more than 90% disintegration in less than 30, 35, 40, 45, 50, 55, 60, 65, 70, 75, 80, 81, 82, 83, 84, 85, 86, 87, 88, 89, or 90 days.

In certain embodiments, the blend composition exhibits more than 90% biodegradation in less than 30, 35, 40, 45, 50, 55, 60, 65, 70, 75, 80, 85, 90, 100, 110, 120, 130, 140, 150, 160, 170, 175, or 180 days under thermophilic temperature conditions.

In certain embodiments, the method includes preparing biodegradable flexible and rigid parts from the biodegradable blend composition via conventional polymer processing techniques including, but not limited to, compression molding, blow molding, injection molding, cast film extrusion, blown extrusion, profile extrusion and thermoforming.

In one embodiment, the step of producing the resin formulation includes extrusion, where the extrudate is formed at a temperature above ambient temperature, preferably in a range of 120° C. to about 250° C.

In certain embodiments, the biodegradable blend compositions of the invention can be used in various embodiments from packaging and single-use products to durable products and in a wide range of applications, from packaging to medical, and consumer products, and many more.

In various embodiments, the invention encompasses a starch-based additive composition comprising of:
[a] about 20 to about 90% (w/w) of one or more biodegradable and compostable starch or modified starch;
[b] about 5 to about 60% (w/w) of one or more of plasticizers;
[c] about 0.2 to about 40% (w/w) of one or more acidifiers;
[d] about 0.1 to about 15 parts per hundred resin (phr), with respect to [a], [b] and [c], of one or more of alkalizers;
[e] a minimum of 5 parts per hundred resin (phr), with respect to [a], [b] and [c], of water;
[f] about 0 to about 20% (w/w) of one or more of additives comprising coupling agents, chain extenders, biomass, minerals, initiators, compatibilizer, peroxides, impact modifiers and pigments.

In various embodiments, a biodegradable blend composition comprising:
i. about 5 to 95% (w/w) of one or more biodegradable thermoplastic polyester;
ii. about 5 to 95% (w/w) of the starch-based additive composition of the invention;
iii. about 0 to about 40% (w/w) of one or more plasticizers;
iv. about 0 to about 40% (w/w) of one or more of inorganic fillers;
v. about 0 to about 40% (w/w) of one or more of biomass fillers;
vi. about 0 to about 10% (w/w) of one or more of additives such as coupling agents, compatibilizing agents, processing aids, chain extenders, initiators, peroxides, impact modifiers and pigments.

In various embodiments, a partially-biobased blend composition comprising:
vii. about 5 to 95% (w/w) of one or more polyolefins;
viii. about 5 to 95% (w/w) of the starch-based additive composition of the invention;
ix. about 0 to about 40% (w/w) of one or more plasticizers;
x. about 0 to about 40% (w/w) of one or more of inorganic fillers;
xi. about 0 to about 40% (w/w) of one or more of biomass fillers;
xii. about 0 to about 10% (w/w) of one or more of additives such as coupling agents, compatibilizing agents, processing aids, chain extenders, initiators, peroxides, impact modifiers and pigments.

In various embodiments, the starch-based additive does not require any processing at elevated temperatures prior to making blend compositions.

In various embodiments, the starch-based additive is gelatinized into TPS at elevated temperatures prior to making blend compositions.

In various embodiments, the starch-based additive composition exhibits a bio-based carbon content of 100%.

In various embodiments, the scratch of the starch-based additive compositions is one or more of starch, in the form of native or modified starch, from
a. cereal grains selected from the group comprising corn of all types, wheat, sorghum, rice, and waxy rice, which can also be used in the flour and cracked state,
b. tubers of all types and nature selected from the group comprising potato, sweet potato, yam, roots (tapioca from cassava and manioc and arrowroot),
c. plant stems and barks selected from the group comprising pith of the sago palm,
d. fruits of all types,
e. other starchy plant parts,
f. or combinations thereof.

In various embodiments, the plasticizer of the starch-based additive compositions comprises one or more polyols, plant-based oils or a combination thereof which are either in their virgin or modified form.

In various embodiments, the plasticizer of the starch-based additive compositions comprises one or more plant-based oils obtained from vegetables, nuts, grains, seeds, wherein the oil is
a. one or more virgin oils selected from the group consisting of corn oil, soybean oil, linseed oil, canola oil, peanut oil, palm oil, cashew oil, cottonseed oil, rapeseed oil, olive oil; or
b. one or more modified oils, modified through different methods selected from the group consisting of epoxidation, carboxylation, hydroxylation and amidation; or
c. one or more modified oils, modified with long and/or short-chain hydrocarbons with functional groups selected from the group consisting of epoxides, hydroxyls, anhydrides, 2,5-Dimethyl-2,5-di(tert-butylperoxy) hexane, citrates; or
d. a combination thereof.

In various embodiments, the plasticizer of the starch-based additive compositions comprises one or more polyols selected from the group consisting of sorbitol, lactitol, maltitol, mannitol, galactitol, xylitol, glycerol, ribitol, arabitol, erythritol, threitol, and a combination thereof.

In various embodiments, the acidifiers of starch-based additive compositions are selected from the group consisting of agaric acid, potassium citrate, propane-1,2,3-tricarboxylic acid, aconitic acid, citric acid, tartaric acid, isocitric acid, sodium lactate, trimesic acid, calcium acetate, and combinations thereof.

In various embodiments, the alkalizer of the starch-based additive compositions comprises calcium carbonate, sodium bicarbonate, potassium citrate, sodium lactate, calcium acetate, and combinations thereof.

In various embodiments, the starch-based additive compositions exhibit a 90% disintegration completion within about 180 to about 365 days in soil at ambient temperature.

In various embodiments, the biodegradable thermoplastic polyester of the biodegradable blend composition is one or more of polymers selected from the group consisting of polylactic acid, polycaprolactone, polybutylene succinate, polybutylene succinate adipate, polybutylene succinate terephthalate, polybutylene adipate-co-terephthalate, polyhydroxyalkanoates and combinations thereof.

In various embodiments, the polyolefin of the partially-biobased blend composition is one or more of polymers selected from the group consisting of polypropylene (PP), homo-polypropylene (homo-PP), co-polypropylene (co-PP), polyethylene (PE), low density polyethylene (LDPE), linear low density polyethylene (LLDPE), high density polypropylene (HDPE), ultra-high-molecular-weight polyethylene (UHMWPE), high-modulus polyethylene (HMPE), thermoplastic elastomers (TPE), ethylene-propylene copolymer (EPC or EPM), polyisobutylene (PIB), polybutene (PB), polyethylene-co-vinyl acetate (EVA), and ethylene-propylene-diene monomer (EPDM).

In certain embodiments, the plasticizer of the biodegradable blend composition is a plant-based oil selected from the group consisting of vegetables, nuts, grains, seeds, or combinations thereof, wherein the oils comprise corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

In certain embodiments, the inorganic filler of the biodegradable blend composition is selected from the group consisting of wollastonite, mica, clay, calcium carbonate, glass fiber, talc, aluminum silicate, zirconium oxide, sepiolite, gypsum and a combination thereof.

In certain embodiments, the biomass of the biodegradable blend composition is selected from distillers' grains, vinasse, vinegar residues, wood fiber, virgin starch, modified starch (including thermoplastic starch), agricultural cellulosic matter, straw, stalk, shive, hurd, bast, leaf, seed, fruit, and perennial grass, all in a non-continuous non-woven form, which may consist of chopped pieces, particulates, dust, or flour.

In various embodiments, the biodegradable blend composition exhibits a bio-based carbon content of up to 100%.

In various embodiments, the biodegradable blend composition exhibits a 90% disintegration completion within about 180 to about 365 days in soil at thermophilic temperature.

In various embodiments, for the method of producing the biodegradable blend composition ingredients are mixed and melt-compounded together in a polymer processing equipment or apparatus including but not limited to a batch mixer, a twin screw extruder or single screw extruder, at elevated temperatures for a time period of several seconds to several minutes.

In various embodiments, the biodegradable blend composition is used to make articles using conventional polymer processing techniques selected from cast film extrusion and injection molding techniques.

In one embodiment, the biodegradable blend composition shows an elongation at break of 790%, a stress at break of 5.9 MPa, and a non-break notched Izod impact strength.

In an embodiment, the biodegradable blend composition shows an elongation at break of 8.5%, a stress at break of 21.5 MPa, and an 80 J/m Izod impact strength.

In another embodiment, the invention encompasses a starch-based additive composition comprising of:
about 20 to about 90% (w/w) of one or more biodegradable and compostable starch or modified starch;
about 5 to about 60% (w/w) of one or more of plasticizers;
about 0.2 to about 40% (w/w) of one or more acidifiers;
about 0.1 to about 15 parts per hundred resin (phr), with respect to [a], [b] and [c], of one or more of alkalizers;
a minimum of 5 parts per hundred resin (phr), with respect to [a], [b] and [c], of water; about 0 to about 20% (w/w) of one or more of additives comprising coupling agents, chain extenders, biomass, minerals, initiators, compatibilizer, peroxides, impact modifiers and pigments.

In another embodiment, the invention encompasses a starch-based additive composition comprising of:
about 35 to about 65% (w/w) of one or more biodegradable and compostable starch or modified starch;
about 15 to about 45% (w/w) of one or more of plasticizers;
about 5 to about 25% (w/w) of one or more acidifiers;
about 2 to about 10 parts per hundred resin (phr), with respect to [a], [b] and [c], of one or more of alkalizers;
a minimum of 5 parts per hundred resin (phr), with respect to [a], [b], and [c], of water; about 0 to about 20% (w/w) of one or more of additives comprising coupling agents, chain extenders, biomass, minerals, initiators, compatibilizer, peroxides, impact modifiers and pigments.

In another embodiment, the invention encompasses a biodegradable blend composition comprising:
about 5 to 90% (w/w) of one or more biodegradable thermoplastic polyester;
about 5 to 95% (w/w) of the starch-based additive composition of claim 1;
about 0 to about 40% (w/w) of one or more plasticizers;
about 0 to about 40% (w/w) of one or more of inorganic fillers;
about 0 to about 40% (w/w) of one or more of biomass fillers;
about 0 to about 10% (w/w) of one or more of additives such as coupling agents, compatibilizing agents, processing aids, chain extenders, initiators, peroxides, impac

In certain embodiments, the starch-based additive does not require any processing at elevated temperatures prior to making biodegradable blend compositions.

In certain embodiments, the starch-based additive composition is gelatinized into thermoplastic starch (TPS) at elevated temperatures in presence of heat and shear using conventional plastic compounding and processing equipment and techniques comprising extrusion and batch mixing.

In certain embodiments, the invention encompasses a biodegradable blend compositions comprising:
about 5 to 90% (w/w) of one or more biodegradable thermoplastic polyester;
about 5 to 95% (w/w) of the thermoplastic starch (TPS) of claim 4;
about 0 to about 40% (w/w) of one or more plasticizers;
about 0 to about 40% (w/w) of one or more of inorganic fillers;
about 0 to about 40% (w/w) of one or more of biomass fillers;
about 0 to about 10% (w/w) of one or more of additives such as coupling agents, compatibilizing agents, processing aids, chain extenders, initiators, peroxides, impact modifiers and pigments.

In certain embodiments, the composition exhibits a bio-based carbon content of 100%.

In certain embodiments, the starch is one or more of starch, in the form of native or modified starch, from cereal grains selected from the group comprising corn of all types, wheat, sorghum, rice, and waxy rice, which can also be used in the flour and cracked state, tubers of all types and nature selected from the group comprising potato, sweet potato, yam, roots (tapioca from cassava and manioc and arrowroot), plant stems and barks selected from the group comprising pith of the sago palm, fruits of all types, other starchy plant parts, or combinations thereof.

In certain embodiments, the plasticizers comprise one or more of polyols, plant-based oils or a combination thereof which are either in their virgin or modified form.

The starch-based additive compositions of claim 1, wherein the plasticizers comprise one or more plant-based oils obtained from vegetables, nuts, grains, seeds, wherein the oil is one or more virgin oils selected from the group consisting of corn oil, soybean oil, linseed oil, canola oil, peanut oil, palm oil, cashew oil, cottonseed oil, rapeseed oil, olive oil; or one or more modified oils, modified through different methods selected from the group consisting of epoxidation, carboxylation, hydroxylation and amidation; or one or more modified oils, modified with long and/or short-chain hydrocarbons with functional groups selected from the group consisting of epoxides, hydroxyls, anhydrides, 2,5-Dimethyl-2,5-di(tert-butylperoxy) hexane, citrates; or a combination thereof.

In certain embodiments, the plasticizers comprise one or more polyols selected from the group consisting of sorbitol, lactitol, maltitol, mannitol, galactitol, xylitol, glycerol, ribitol, arabitol, erythritol, threitol, and a combination thereof.

In certain embodiments, the acidifiers are selected from the group consisting of agaric acid, potassium citrate, propane-1,2,3-tricarboxylic acid, aconitic acid, citric acid, tartaric acid, isocitric acid, sodium lactate, trimesic acid, calcium acetate, and combinations thereof.

In certain embodiments, the alkalizer comprises calcium carbonate, sodium bicarbonate, potassium citrate, sodium lactate, calcium aceteate, and combinations thereof.

In certain embodiments, the composition exhibits a 90% disintegration completion within about 180 to about 365 days in soil at ambient temperature.

In certain embodiments, the biodegradable thermoplastic polyester is one or more of polymers selected from the group consisting of polylactic acid, polycaprolactone, polybutylene succinate, polybutylene succinate adipate, polybutylene succinate terephthalate, polybutylene adipate-co-terephthalate, polyhydroxyalkanoates and combinations thereof.

In certain embodiments, the plasticizer of the blend is a plant-based oil selected from the group consisting of vegetables, nuts, grains, seeds, or combinations thereof, wherein the oils comprise corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

In certain embodiments, the inorganic filler is selected from the group consisting of wollastonite, mica, clay, calcium carbonate, glass fiber, talc, aluminum silicate, zirconium oxide, sepiolite, gypsum and a combination thereof.

In certain embodiments, the biomass is selected from distillers' grains, vinasse, vinegar residues, wood fiber, virgin starch, modified starch (including thermoplastic starch), agricultural cellulosic matter, straw, stalk, shive, hurd, bast, leaf, seed, fruit, and perennial grass, all in a non-continuous nonwoven form, which may consist of chopped pieces, particulates, dust, or flour.

In certain embodiments, the bio-based carbon content of the composition is up to 100%.

In certain embodiments, the composition exhibits a 90% disintegration completion within about 180 to about 365 days in soil at ambient temperature.

In certain embodiments, the ingredients are mixed and melt-compounded together in a polymer processing equipment or apparatus including but not limited to a batch mixer, a twin screw extruder or single screw extruder, at elevated temperatures for a time period of several seconds to several minutes.

In certain embodiments, the composition is used to make flexible and rigid articles using conventional polymer processing techniques selected from cast film extrusion, blown film extrusion, compression molding, thermoforming and injection molding techniques.

In certain embodiments, the blends show an elongation at break of 790%, a stress at break of 5.9 MPa, and a non-break notched Izod impact strength.

In certain embodiments, the blends show an elongation at break of at least 8.5%, a stress at break of at least 21.5 MPa, and a notched Izod impact strength of at least 80 J/m.

In certain embodiments, the TPS exhibits no retrogradation over time.

In certain embodiments, the TPS exhibits thermal stability of less than a 9 wt. % mass loss at a temperature of 200° C., tested in air and at a heating rate of 20° C./min using a thermogravimetric analyzer (TGA).

In certain embodiments, the TPS exhibits a thermal degradation onset temperature of more than 140° C., tested in air and at a heating rate of 20° C./min using a thermogravimetric analyzer (TGA).

In certain embodiments, the TPS exhibits a long-term processability using conventional plastic processing techniques of at least 12 months after being produced.

In certain embodiments, the TPS exhibits process recyclability as indicated by remelting and reforming using conventional plastic processing techniques of at least 10 cycles after being produced.

In certain embodiments, the TPS exhibits long-term durability as indicated by the less than 10% changes to mechanical properties comprising tensile strength, elongation and modulus over a period of at least 12 months.

In certain embodiments, the TPS exhibits low hygroscopicity with a maximum of 0.5% increase in moisture uptake over a period of 12 months in an environment with at most 30% relative humidity.

In certain embodiments, the TPS exhibits a 90% disintegration completion within about 180 to about 365 days in soil at ambient temperature.

In certain embodiments, the TPS exhibits more than 90% disintegration in less than 84 days and more than 90% biodegradation in less than 180 days under ASTM D6400, and under thermophilic temperature conditions.

In certain embodiments, the ingredients are mixed and melt-compounded together in a polymer processing equipment or apparatus selected from the group consisting of a batch mixer, a twin screw extruder or single screw extruder, at elevated temperatures ranging from about 50° C. to about 200° C. for a time period of several seconds to several minutes.

### BRIEF DESCRIPTION OF THE DRAWINGS

FIG. 1 is an exemplary image of the biodegradable and compostable TPS composition sheets compression molded over an extended period of time, showcasing the reprocessability and elimination of retrogradation of Example 1. Sheets of Example 5 over a 10 week period, compression molded: (A) immediately after production, (B) 1 week after production, (C) 2 weeks after production, (D) 3 weeks after production, (E) 4 weeks after production, (F) 5 weeks after production, (G) 6 weeks after production, (H) 7 weeks after production, (I) 8 weeks after production, (J) 9 weeks after production, and (K) 10 weeks after production.

FIG. 2 is an exemplary graphical representation of the mechanical properties of the biodegradable and compostable TPS composition over an extended period of time, showcasing stability and durability. FIG. 2 illustrates (A) Stress at Yield, (B) Elongation at Break, (C) Young's Modulus and (D) Stress at Break of test strips from Example 6 tested weekly, over a period of 9 weeks.

FIG. 3 is an exemplary graphical representation of the mechanical properties of the biodegradable and compostable PLA/TPS resin composition over multiple recycling of the TPS prior to blending with the PLA, showcasing the thermal stability and durability. FIG. 3 illustrates (A) Stress at Yield, (B) Elongation at Break, (C) Stress at Break and (D) Young's Modulus of injection molded test tensile test bars from Example 7.

### DETAILED DESCRIPTION OF THE INVENTION

### Definitions

To facilitate an understanding of the invention, it will be described more comprehensively herein below. However, the invention may be embodied in different forms and is not limited to the embodiments set forth herein. Rather, these embodiments are provided for the purpose of making the disclosure of the invention more thorough and comprehensive.

Unless otherwise defined, all technical and scientific terms used herein have the same meaning as those commonly understood by a person skilled in the art to which the present invention belongs. Terms used in the specification of the present invention are only for the purpose of describing specific embodiments, and are not intended to limit the present invention.

The term “additive” as used herein could refer to material used to enhance a targeted property or function of material and/or composition, which could be in any form such as solid, liquid, powder, fiber, or crystal.

The term “acidifier” as used herein refers to any additive that is used to neutralize a basic environment or used to decrease its pH to be more acidic.

The term “alkalizer” as used herein refers to any additive that is used to neutralize an acidic environment or used to increase its pH to be more basic.

The prefix “bio” as used herein refers to a material that has been derived from a renewable biological resource.

The term “biobased” or “bio-based” refers to compositions or materials that are derived from plant matter, instead of being made from petroleum or natural gas. Because these are plant-based, there is a tendency to assume that the type of composition or material must be biodegradable. However, this is not the case for all plant-based compositions. The bio-based compositions of the invention can be designed to biodegrade in less than 6 months.

The term “biodegradable” refers to compositions of the invention that can biodegrade within 12 months in a compost environment in a non-toxic, environmentally compatible manner with no heavy metal or PTFE contents, while remaining soil-safe (i.e., lack of eco-toxins). The compositions of the invention biodegrade within 12 months. Compostable plastic is biodegradable, but not every plastic that is biodegradable is compostable. The compositions of the invention are both biodegradable and compostable. As used herein, “biodegradable” compositions are engineered to biodegrade in compost, soil, or water. In particular, biodegradable plastics are plastics with innovative molecular structures that can be decomposed by bacteria at the end of their life under certain environmental conditions.

The term “bioplastics” or “biopolymer” is used to refer to plastics that are bio-based, biodegradable, or fit both criteria. Bio-based plastics of the invention are fully made from renewable feedstock derived from biomass. Commonly used raw materials to produce the renewable feedstock for plastic production include, but are not limited to, starch, plant stalks, glycogen, sugarcane stems, cellulose and its derivatives, and various oils and fats from renewable sources.

The terms “blend” and “resin” as used herein, refer to a homogeneous mixture of two or more polymers along with other ingredients.

As used herein, “compostable” compositions refer to biodegradation into soil conditioning material (i.e., compost). In order for a plastic to be labeled as commercially “compostable” it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standards D6400 and D6868 outline the specifications that must be met in order to label a plastic as “industrial compostable”.

The term “disintegration” refers to a plastic product that leaves no more than 10% of its original dry weight after twelve weeks (84 days) in a controlled thermophilic composting test and sieved through a 2.0-mm mesh.

The term “durable” as used herein, is defined as the ability of the thermoplastic starch compositions to maintain its distinct physical and mechanical, and thermal properties over an extended period of two years from its production date without any retrogradation during that time period. In regards to this patent, the physical and mechanical, and thermal properties which are of importance are ductility, elasticity, toughness and thermal stability.

The term “modified starch” is herein defined as starch is transformed from its native form by typical processes known in the art including, physical, physiochemical, biological, biochemical or chemical processes such as, for example, plasticization, esterification, etherification, oxidation, acid hydrolysis, cross-linking, and enzyme conversion. Typical starch or modified starches include esters, such as the acetate and, the half-esters of dicarboxylic acids/anhydrides, particularly the alkenyl succinic acids/anhydrides; ethers, such as the hydroxyethyl and hydroxypropyl starches; oxidized starches, such as those oxidized with hypochlorite; starches reacted with cross-linking agents, such as phosphorus oxychloride, epichlorohydrin, hydrophobic cationic epoxides, and phosphate derivatives prepared by reaction with sodium or potassium orthophosphate or tripolyphosphate, and combinations thereof. Preferred starches can include any starch or modified starch that is initially in a native state as a granular solid, and obtained from sources such as, but not limited to fruits of all types, starchy plant parts, cereal grains (e.g, corn, waxy corn, wheat, sorghum, rice, and waxy rice, which can also be used in the flour and cracked state), tubers of all types and nature such as potato, roots (tapioca (i.e., cassava and manioc), sweet potato, and arrowroot, modified cornstarch, and the pith of the sago palm. Other ingredients of the modified starch could contain at least one polyol including but not limited to sorbitol, mannitol, galactitol, xylitol, ribitol, arabitol, erythritol, glycerol, threitol and a derivative thereof, and at least one organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof, and additives such as but not limited to crosslinkers, initiators, alkalizers, acidifiers, peroxides, coupling agents, fillers, compatibilizing agents and combinations thereof.

The term “phr” or “parts per hundred resin” as used herein, interchangeably, refers to a percentage of an additive to be added to a unit of a material or formulation which comprises two or more ingredients, without changing the ratio of the ingredients in the material or formulation.

The term “plasticization” or “gelatinization” as used herein, interchangeably, refers to the penetration of plasticizers between the chains of the polysaccharide, allowing for increased mobility, which leads to swelling and viscous gel formation.

As used herein, “plasticizer” could refer to material used to enhance gelatinization of starch while maintaining the plasticity, flexibility, toughness or reduce brittleness of TPS.

The term “premix” refers to a physical mixture of ingredients at ambient temperature using any mechanical means of mixing, either by equipment or hand-mixed.

The term “polyesters” refers to polymers of the invention that are obtained, for example, from aliphatic diols, aliphatic dicarboxylic acids, and aromatic dicarboxylic acids/esters. The term polyesters also includes aliphatic and aliphatic-aromatic polyesters. The “biodegradable thermoplastic polyesters” of the current invention include but are not limited to polylactic acid (PLA) or poly(lactic acid) (PLA); polycaprolactone (PCL); poly(butylene succinate) (PBS) or polybutylene succinate (PBS); poly(butylene succinate adipate) (PBSA), polybutylene succinate adipate (PBSA), poly(butylene succinate-co-adipate) (PBSA), polybutylene succinate-co-adipate (PBSA), poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); polyhydroxyalkanoates (PHAs), and combinations thereof.

The term “polyhydroxyalkanoates (PHAs)” refers to a family of bio-based thermoplastic polyesters synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

The term “recrystallization” as used herein refers to the packing of the plasticized molecule chains over time as plasticizers begin to migrate out from in between the chains of the molecules due to strong intramolecular hydrogen bond interactions between these chains and unto the surface of the bulk material.

The term “retrogradation” as used herein, refers specifically to thermoplastic polysaccharides such as but not limited to thermoplastic starch, where the modified or plasticized starch molecules undergo recrystallization of its molecular chains due to the leach-out of the plasticizer used, leading to loss of mobility and its gel-like state.

The term “reprocessabilty” or “recyclability” as used herein, interchangeably, refers to the ability of a thermoplastic material to melt at elevated temperatures and form and solidify into an article of desired shape multiple times without undergoing a significant loss in mechanical and physical properties.

The term “starch-based additive” is defined herein as a blend comprising one or more starches and/or modified starches and additional ingredients, including but not limited to polyols, organic acids, and various additives such as water, crosslinkers, initiators, alkalizers, acidifiers, peroxides, coupling agents, fillers, compatibilizing agents, pigments, and their combinations. Importantly, the starch-based additive does not require any further processing beyond mixing at ambient temperatures.

The term “thermoplastic”, as used herein, refers to a polymer, which softens when heated, becomes moldable and pliable, and then solidifies when cooled.

The term “thermoplastic starch” is herein defined to refer to thermoplastic polymers produced from one or more starch that has been gelatinized in the presence of heat above ambient temperature and shear, using ingredients such as but not limited to one or more polyols, organic acids and additives such as but not limited to crosslinkers, initiators, alkalizers, acidifiers, peroxides, coupling agents, fillers, compatibilizing agents, pigments and combinations thereof.

The term “wt. %,” “parts by mass (w/w)” or “parts by mass % (w/w)”, as used herein, refer to the percentage weight of an ingredient of a composition with respect to the total weight of the composition.

### Ingredients of the Durable TPS Compositions of the Invention

The present invention is concerned with the development of 100% biobased biodegradable and compostable durable TPS compositions that exhibit elastomeric-like properties. Its durability refers to its ability to be reprocessed after an extended period from its production date, multi-recyclability and complete elimination of retrogradation. In general, the biodegradable compositions of the invention can be considered valid alternative materials to those produced partly from petroleum resources.

The biodegradable TPS compositions of the invention are derived from natural resources. In certain embodiments, the TPS of the invention include biodegradable starch and/or modified starch from an unlimited range of sources.

In certain embodiments, the biodegradable TPS includes, but is not limited to, one or more of starch, in the form of native or modified starch, from fruits of all types, starchy plant parts, cereal grains (e.g, corn, waxy corn, wheat, sorghum, rice, and waxy rice, which can also be used in the flour and cracked state), tubers of all types and nature such as potato, roots (tapioca from cassava and manioc), sweet potato, and arrowroot, modified cornstarch, and the pith of the sago palm or combinations thereof.

The embodiment compositions may include, but are not limited to, any of the following starch combinations:

In certain embodiments, the biodegradable TPS include tapioca starch and cornstarch.

In certain embodiments, the biodegradable TPS includes tapioca starch and modified cornstarch.

In certain embodiments, the biodegradable TPS include modified tapioca starch and cornstarch.

In certain embodiments, the biodegradable TPS include modified tapioca starch and modified cornstarch.

In certain embodiments, the biodegradable TPS include wheat starch and cornstarch.

In certain embodiments, the biodegradable TPS include wheat starch and modified cornstarch.

In certain embodiments, the biodegradable TPS include modified wheat starch and cornstarch.

In certain embodiments, the biodegradable TPS include modified wheat starch and modified cornstarch.

In certain embodiments, the biodegradable TPS include waxy rice starch and cornstarch.

In certain embodiments, the biodegradable TPS include waxy rice starch and modified cornstarch.

In certain embodiments, the biodegradable TPS include modified waxy rice starch and cornstarch.

In certain embodiments, the biodegradable TPS include modified waxy rice starch and modified cornstarch.

In certain embodiments, the biodegradable TPS includes wheat and waxy rice starch.

In certain embodiments, the biodegradable TPS include wheat and modified waxy rice starch.

In certain embodiments, the biodegradable TPS include modified wheat and waxy rice starch.

In certain embodiments, the biodegradable TPS include modified wheat and modified waxy rice starch.

In certain embodiments, the biodegradable TPS include wheat and tapioca starch.

In certain embodiments, the biodegradable TPS include wheat and modified tapioca starch.

In certain embodiments, the biodegradable TPS include modified wheat and tapioca starch.

In certain embodiments, the biodegradable TPS includes modified wheat and modified tapioca starch.

In certain embodiments, the biodegradable TPS include potato and tapioca starch.

In certain embodiments, the biodegradable TPS include potato and modified tapioca starch.

In certain embodiments, the biodegradable TPS include modified potato and tapioca starch.

In certain embodiments, the biodegradable TPS includes modified potato and modified tapioca starch.

In certain embodiments, the biodegradable TPS include potato and wheat starch.

In certain embodiments, the biodegradable TPS include potato and modified wheat starch.

In certain embodiments, the biodegradable TPS includes modified potato and wheat starch.

In certain embodiments, the biodegradable TPS include modified potato and modified wheat starch.

In certain embodiments, the biodegradable TPS include potato and waxy rice starch.

In certain embodiments, the biodegradable TPS include potato and modified waxy rice starch.

In certain embodiments, the biodegradable TPS include modified potato and waxy rice starch.

In certain embodiments, the biodegradable TPS include modified potato and modified waxy rice starch.

The abovementioned embodiments are not limited to binary combinations of biodegradable starch but could encompass combinations of three or more biodegradable starch.

The plasticizers of the invention include, but are not limited to water, polyols and plant-based oils. The plant-based oils could be virgin from various sources including but not limited to vegetable, nuts, grains, seeds, etc.: e.g. corn oil, soybean oil, linseed oil, canola oil, peanut oil, palm oil, cashew oil, cottonseed oil, rapeseed oil, olive oil, etc. The plant-based oils could further be modified through different methods including but not limited to epoxidation, carboxylation, hydroxylation and amidation. The plant-based oil could further be modified with long and/or short chain hydrocarbons with functional groups such as but not limited to epoxides, hydroxyls, anhydrides, 2,5-Dimethyl-2,5-di(tert-butylperoxy) hexane and citrates. Polyols are inclusive of the following but not limited to sorbitol, lactitol, maltitol, mannitol, galactitol, xylitol, glycerol, ribitol, arabitol, erythritol and threitol.

The acidifiers of the invention include, but are not limited to organic acids such as adipic acid, azelaic acid, brassylic acid, dodecanedioic acid, glutaric acid, succinic acid, pimelic acid, suberic acid, citric acid, sebacic acid, undecanedioic acid, lactic acid, tetradecanedioic acid, agaric acid, propane-1,2,3-tricarboxylic acid, aconitic acid, tartaric acid, isocitric acid, trimesic acid, pentadecanedioic acid, oxalic acid, malonic acid, glutamic acid, aspartic acid, itaconic acid, glucaric acid and hexadecanedioic acid.

The alkalizer of the invention includes, but are not limited to, calcium carbonate, sodium bicarbonate, potassium citrate, sodium lactate and calcium acetate.

The biodegradable TPS composition can further include additives such as but not limited to crosslinkers, initiators, peroxides, coupling agents, processing aids, pigments, and chain extenders.

The biodegradable TPS compositions can optionally further include biomass fillers and organic fillers including but not limited to distillers' grains, vinasse, vinegar residues, wood fiber, virgin starch, grains, agricultural cellulosic matter from the following but not limited to straw, stalk, shive, hurd, bast, leaf, seed, fruit, and perennial grass, all in a non-continuous non-woven form including chopped pieces, particulates, dust or flour.

The biodegradable TPS compositions can optionally include inorganic fillers including, but not limited to, wollastonite, mica, clay, talc, silicon dioxide, calcium carbonate, glass fiber, aluminum and magnesium silicates, zirconium oxide, iron oxides, glass fibers and bids, sepiolite, and gypsum.

The biodegradable TPS composition comprises about 20 to about 90% (w/w) of one or more biodegradable starch; about 0.2 to about 40% (w/w) of one or more acidifiers; about 5 to about 60% (w/w) of one or more plasticizers; about 0.1 to about 15 parts per hundred resin (phr) of one or more alkalizers with respect to starch, acidifier and plasticizer; about a minimum of 5 parts per hundred resin (phr) of water with respect to starch, acidifier and plasticizer; about 0 to about 20% (w/w) of one or more of fillers which could include inorganic, organic or a combination thereof; about 0 to about 10% (w/w) of one or more of additives such as coupling agents, processing aids, compatibilizers, chain extenders, initiators, peroxides, impact modifiers and pigments.

The ingredients may be processed together in various scenarios but not limited to the following: In one scenario, all ingredients are premixed and melt-processed. In another scenario, the starch will be plasticized in the presence of other ingredients, i.e., melt-processed with at least one plasticizer and other ingredients, and then optionally melt-processed with filler and/or other additives. In yet another scenario, one of the starches will be plasticized, followed by the addition of other starch(es), plasticizer(s) and additives, and optionally fillers. In another scenario, one or more starch will be plasticized and further melt-reprocessed downstream with another one or more plasticized starch that is being processed in tandem to the plasticized starch and additives, and optionally with fillers. In another scenario, the plasticizers are premixed with other ingredients and additives, and optionally with fillers melt-processed before the addition of one or more starch. Furthermore, the optional additives and/or fillers may be added to the starch(es) and melt processed before the addition of the plasticizer(s). In yet another scenario, one or more of the starches(es) may be modified prior to addition in any of the aforementioned scenarios. The blending or processing of the ingredients is not limited to the scenarios but may include all possible ingredient combinations and scenarios.

The blending of the ingredients may be achieved using mixing and melt-compounding equipment with adjustable and controllable temperatures, mixing speeds and barrel pressures. During production, the barrel pressure could be set to atmospheric pressure or put under vacuum. These melt-compounding equipment could be but not limited to single or twin-screw extruder or a batch kneader. In a batch kneader, the processing temperature profile may range from 90 to 180° C., and the processing time may be between about 1 to about 60 minutes. Alternatively, in scenarios where single or twin-screw extrusion is employed, the temperature profile may range from about 50 to about 180° C., and the screw speed may range from about 50 to about 500 rpm. Typically, a continuous amount of premixed ingredients is fed through the hopper of the extruder if used. In cases where a batch mixer is used, a set amount, for example 2 kg of premixed ingredients is fed into a batch mixer with a 2.2 kg holding capacity. It should be noted that the processing conditions provided herein are not limiting and may vary based on other conditions such as ingredient ratios and processing equipment. The resulting product may be formed into films or sheets using conventional cast extrusion, blown film extrusion or compression molding techniques. The resulting product may also be formed into rigid parts using conventional injection molding, compression molding or thermoforming machines. The extrusion, injection molding, thermoforming or compression molding temperature is typically within the range used in the melt-processing and compounding of the TPS ingredients.

The biodegradable starch-based additives of the invention are derived from natural resources. In certain embodiments, the starch-based additive of the invention includes biodegradable starch and/or modified starch from an unlimited range of sources.

In certain embodiments, the biodegradable starch-based additive includes but is not limited to, one or more of starch from fruits of all types, starchy plant parts, cereal grains (e.g, corn, waxy corn, wheat, sorghum, rice, and waxy rice, which can also be used in the flour and cracked state), tubers of all types and nature such as potato, roots (tapioca from cassava and manioc), sweet potato, and arrowroot, modified corn starch, and the pith of the sago palm or combinations thereof.

In various embodiments, plasticizers for the starch-based additive of the invention include but are not limited to water, polyols and plant-based oils. The plant-based oils could be virgin from various sources including but not limited to vegetable, nuts, grains, seeds, etc.: e.g. corn oil, soybean oil, linseed oil, canola oil, peanut oil, palm oil, cashew oil, cottonseed oil, rapeseed oil, olive oil, etc. The plant-based oils could further be modified through different methods including but not limited to epoxidation, carboxylation, hydroxylation and amidation. The plant-based oil could further be modified with long and/or short-chain hydrocarbons with functional groups such as but not limited to epoxides, hydroxyls, anhydrides, 2,5-Dimethyl-2,5-di(tert-butylperoxy) hexane and citrates. Polyols are inclusive of the following but not limited to sorbitol, lactitol, maltitol, mannitol, galactitol, xylitol, glycerol, ribitol, arabitol, erythritol and threitol.

In various embodiments, the raw materials for preparing the starch-based additive further include one or more acidifiers such as, but not limited to agaric acid, potassium citrate, propane-1,2,3-tricarboxylic acid, aconitic acid, citric acid, tartaric acid, isocitric acid, sodium lactate, trimesic acid and calcium acetate.

In various embodiments, the raw materials for preparing the starch-based additive further include one or more alkalizer which could be but not limited to calcium carbonate, sodium bicarbonate, potassium citrate, sodium lactate and calcium acetate.

In certain embodiments, the starch-based additive can further include additives such as but not limited to crosslinkers, initiators, peroxides, coupling agents, processing aids, pigments, and chain extenders.

In certain embodiments, the starch-based additive can optionally further include biomass fillers and organic fillers including but not limited to distillers' grains, vinasse, vinegar residues, wood fiber, virgin starch, grains, agricultural cellulosic matter from the following but not limited to straw, stalk, shive, hurd, bast, leaf, seed, fruit, and perennial grass, all in a non-continuous non-woven form including chopped pieces, particulates, dust or flour.

In various embodiments, the biodegradable starch-based additive comprises about 20 to about 90% (w/w) of one or more biodegradable starch; about 0.2 to about 40% (w/w) of one or more acidifiers; about 5 to about 60% (w/w) of one or more plasticizers; about 0.1 to about 15 parts per hundred resin (phr) of one or more alkalizers with respect to the starch, plasticizer and acidifier composition; about 5 parts per hundred resin (phr) of water with respect to the starch, plasticizer and acidifier composition; about 0 to about 20% (w/w) of one or more compatibilizers; about 0 to about 20% (w/w) of one or more of fillers which could include inorganic, organic or a combination thereof; about 0 to about 20% (w/w) of one or more of additives such as coupling agents, processing aids, chain extenders, initiators, peroxides, impact modifiers and pigments.

The ingredients may be mixed together in various scenarios but not limited to the following: In one scenario, all ingredients are mixed simultaneously. In another scenario, the starch and the plasticizer are mixed in the presence of other ingredients, and then optionally filler and/or other additives will be added. In yet another scenario, one of the starches(es) will be mixed with the plasticizer, followed by the addition of other starch(es), plasticizer(s) and additives, and optionally fillers. In another scenario, the plasticizers are mixed with other ingredients and additives, and optionally with fillers before the addition of one or more starch.

Furthermore, the optional additives and/or fillers may be added to the starch(es) before the addition of the plasticizer(s). In yet another scenario, one or more of the starches(es) may be modified before addition in any of the aforementioned scenarios. The mixing order of the ingredients is not limited to the scenarios but may include all possible ingredient combinations and scenarios.

The mixture of the ingredients may be achieved using mixing equipment with adjustable mixing speed such as industrial mixers. The starch-based additive can be prepared at room temperature, and the mixing time may be between about 1 to about 60 minutes and the mixing speed may range from about 10 to about 500 rpm or more. It should be noted that the processing conditions provided herein are not limiting and may vary based on other conditions such as ingredient ratios and processing equipment.

In various embodiments, the biodegradable blend composition of the invention encompasses the starch-based additive of this invention in parts by mass (w/w) of about 5 to 95%. In various embodiments, the parts by mass (w/w) of starch-based additive in the biodegradable blend composition are about 5, 10, 20, 30, 40, 50, 60, 70, 80, 90 and 95 wt. %.

In various embodiments, the blend composition further includes at least one biodegradable thermoplastic polyester. In various embodiments, the biodegradable thermoplastic polyesters include but are not limited to polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT) and polyhydroxyalkanoates (PHAs).

The parts by mass (w/w) of the biodegradable thermoplastic polyesters in the blend composition are about 5 to 95 wt. %. In various embodiments, the parts by mass (w/w) of biodegradable thermoplastic polyester in the resin are about 5, 10, 20, 30, 40, 50, 60, 70, 80, 90 and 95 wt. %.

In one embodiment, the biodegradable blend composition further includes in parts by mass (w/w) of about 0 to about 40 of at least one plasticizer. In various embodiments, the amount of the plasticizer is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In one embodiment, the plasticizers include but are not limited to, plant-based oils obtained from sources such as vegetables, nuts, grains, seeds, etc. Examples of such oils include, but are not limited to, corn oil, soybean oil, and glycerol. These plant-based oils can be used either in their virgin or modified form (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In another embodiment, the biodegradable blend composition further includes in parts by mass (w/w) of about 0 to about 10 of at least one bio-based organic acid compatibilizer including, but not limited to lactic acid, formic acid, stearic acid, tannic acid, malic acid, citric acid, aspartic acid, ascorbic acid, acetic acid, tartaric acid. In various embodiments, the amount of the organic acid compatibilizer is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable blend composition further includes, in parts by mass (w/w) of about 0 to about 10 of one or more coupling agents which encompasses both short and long-chain hydrocarbons with functional groups such as but not limited to epoxides, hydroxyls, anhydrides and citrates. In various embodiments, the amount of the coupling agent is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable blend composition further includes, in parts by mass (w/w) of about 0 to about 40 of one or more fillers which encompasses both inorganic and biomass fillers and a combination thereof. In various embodiments, the amount of the inorganic and/or biomass fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In certain embodiments, the inorganic fillers are, but not limited to, wollastonite, mica, clay, calcium carbonate, glass fiber, talc, aluminum silicate, silicon dioxide, zirconium oxide, sepiolite, gypsum, and other minerals and a combination thereof.

In certain embodiments, the biomass includes, but not limited to, distillers' grains vinasse, vinegar residues, wood fiber, virgin starch, modified starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the blend composition could further include compatibilizers, chain extenders, peroxides, initiators, pigments, cross-linkers, or a combination thereof in a weight ratio range from about 0 to about 10 wt. %. In various embodiments, the amount of one or more compatibilizers, chain extenders, peroxides, initiators, pigments, cross-linkers, or a combination thereof is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

The ingredients may be processed together in various scenarios. In one embodiment, all ingredients are premixed and melted together.

In another embodiment, the biodegradable thermoplastic polyester(s) is melted first, and then the starch-based additive is added to the system before the addition of other additives.

In another embodiment, the starch-based additive is first charged into the processing equipment, and then the biodegradable thermoplastic polyester(s) are added to the system before other additives.

In another embodiment, the biodegradable thermoplastic polyester(s) is melted first, and then the other additives are added to the system before the addition of the starch-based additive.

In yet another embodiment, the starch-based additive is added first, and then the other additives are added to the system before the addition of biodegradable thermoplastic polyester(s).

The order of introducing the ingredients to the system is not limited to these embodiments and may include any other embodiments and combinations.

In one embodiment, the blending of the ingredients may be achieved using mixing and melt-compounding equipment with adjustable and controllable temperatures, such as a single or twin screw extruder, or a batch mixer. In a batch mixer, the processing temperature profile may range from 50 to 250° C., and the processing time may be between 1 to 60 minutes.

Alternatively, in embodiments where single or twin-screw extrusion is employed, the temperature profile may range from 50 to 250° C., and the screw speed may range from 20 to 500 rpm. It should be noted that the processing conditions provided herein are not limited and may vary based on other conditions such as ingredient amounts and ratios and the type of processing equipment.

The resulting product may be pelletized and subsequently formed into desired shapes and parts using conventional forming techniques including, but not limited to, injection molding, compression molding, thermoforming, film blowing, or extrusion. The forming temperature is typically within the range used in the melt-processing and compounding of the resins and ingredients.

In various embodiments, the biodegradable blend composition of the invention encompasses gelatinized TPS in parts by mass (w/w) of about 5 to 95%. In various embodiments, the parts by mass (w/w) of TPS in the blend composition are about 5, 10, 20, 30, 40, 50, 60, 70, 80, 90 and 95 wt. %.

In various embodiments, the blend composition further includes at least one biodegradable thermoplastic polyester. In various embodiments, the biodegradable thermoplastic polyesters include but are not limited to polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT) and polyhydroxyalkanoates (PHAs).

The biodegradable thermoplastic polyesters in the blend composition are in parts by mass (w/w) of about 5 to 95 wt. %. In various embodiments, the biodegradable thermoplastic polyesters in the resin are in parts by mass (w/w) of about 5, 10, 20, 30, 40, 50, 60, 70, 80, 90 and 95 wt. %.

In one embodiment, the biodegradable blend composition further includes in parts by mass (w/w) of about 0 to about 40 of at least one plasticizer. In various embodiments, the amount of the plasticizer is about 0.01%, 0.05%, 0.1%, 0.2%, 0.3%, 0.4%, 0.5%. 0.6%, 0.7%, 0.8%, 0.9%, 10%, 2%, 3%, 4%, 5%, 6%, 7%, 8%, 9%, 10%, 12.50%, 150%, 17.50%, 20%, 22.50%, 25%, 27.5%, 30%, 32.5%, 35%, 37.5%, or about 40%.

In one embodiment, the plasticizers include but are not limited to, plant-based oils obtained from sources such as vegetables, nuts, grains, seeds, etc. Examples of such oils include, but are not limited to, corn oil, soybean oil, and glycerol. These plant-based oils can be used either in their virgin or modified form (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In another embodiment, the biodegradable blend composition further includes in parts by mass (w/w) of about 0 to about 10 of at least one bio-based organic acid compatibilizer including, but not limited to lactic acid, formic acid, stearic acid, tannic acid, malic acid, citric acid, aspartic acid, ascorbic acid, acetic acid, tartaric acid. In various embodiments, the amount of the organic acid compatibilizer is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable blend composition further includes, in parts by mass (w/w) of about 0 to about 10 of one or more coupling agents which encompasses both short and long-chain hydrocarbons with functional groups such as but not limited to epoxides, hydroxyls, anhydrides and citrates. In various embodiments, the amount of the coupling agent is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable blend composition further includes, in parts by mass (w/w) of about 0 to about 40 of one or more fillers which encompasses both inorganic and biomass fillers and a combination thereof. In various embodiments, the amount of the inorganic and/or biomass fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In certain embodiments, the inorganic fillers are, but not limited to, wollastonite, mica, clay, calcium carbonate, glass fiber, talc, aluminum silicate, silicon dioxide, zirconium oxide, sepiolite, gypsum, and other minerals and a combination thereof.

In certain embodiments, the biomass includes, but not limited to, distillers' grains vinasse, vinegar residues, wood fiber, virgin starch, modified starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the blend composition could further include compatibilizers, chain extenders, peroxides, initiators, pigments, cross-linkers, or a combination thereof in a weight ratio range from about 0 to about 10 wt. %. In various embodiments, the amount of one or more compatibilizers, chain extenders, peroxides, initiators, pigments, cross-linkers, or a combination thereof is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

The ingredients may be processed together in various scenarios. In one embodiment, all ingredients are premixed and melt-processed together.

In another embodiment, the biodegradable thermoplastic polyester(s) is melted first, and then the thermoplastic starch is added to the system before the addition of other additives.

In another embodiment, the thermoplastic starch is first charged into the processing equipment, and then the biodegradable thermoplastic polyester(s) are added to the system before other additives.

In another embodiment, the biodegradable thermoplastic polyester(s) is melted first, and then the other additives are added to the system before the addition of thermoplastic starch.

In yet another embodiment, the thermoplastic starch is melted first, and then the other additives are added to the system before the addition of biodegradable thermoplastic polyester(s).

The order of introducing the ingredients to the system is not limited to these embodiments and may include any other embodiments and combinations.

In one embodiment, the blending of the ingredients may be achieved using mixing and melt-compounding equipment with adjustable and controllable temperatures, such as a single or twin screw extruder, or a batch mixer. In a batch mixer, the processing temperature profile may range from 50 to 250° C., and the processing time may be between 1 to 60 minutes.

Alternatively, in embodiments where single or twin-screw extrusion is employed, the temperature profile may range from 50 to 250° C., and the screw speed may range from 20 to 500 rpm. It should be noted that the processing conditions provided herein are not limited and may vary based on other conditions such as ingredient amounts and ratios and the type of processing equipment.

The resulting product may be pelletized and subsequently formed into desired shapes and parts using conventional forming techniques including, but not limited to, injection molding, compression molding, thermoforming, film blowing, or extrusion. The forming temperature is typically within the range used in the melt-processing and compounding of the resins and ingredients.

The invention generally encompasses compositions and methods of manufacturing a biodegradable composition including, but not limited to, about 20 to about 90% (w/w) of one or more biodegradable starch; about 0.2 to about 40% (w/w) of one or more acidifiers; about 5 to about 60% (w/w) of one or more of plasticizers; about 0.1 to about 15 phr of one or more of alkalizers with respect to starches, plasticizers and acidifiers; a minimum of 5 phr of water with respect to starches, plasticizers and acidifiers; and optionally, about 0 to about 20% (w/w) of one or more of additives such as coupling agents, processing aids, compatibilizers, minerals, biomass, chain extenders, initiators, peroxides, impact modifiers and pigments.

The methods of manufacturing of the composition combinations may be achieved using mixing and melt-compounding equipment with adjustable and controllable temperatures and mixing speeds, such as a single or twin screw extruder or a batch kneader. In a batch kneader, the processing temperature profile may range from about 50 to about 200° C., and the processing time may be between about 1 to 60 minutes.

Alternatively, in scenarios where single or twin-screw extrusion is employed, the temperature profile may range from about 50 to about 200° C., and the screw speed may range from about 50 to about 500 rpm. It should be noted that the processing conditions provided herein are not limiting and may vary based on other conditions such as ingredient ratios and processing equipment. The resulting product may be extruded into films, sheets or more rigid parts using conventional cast extrusion, blown film extrusion, injection molding or compression molding techniques. Alternatively, the resulting product may be pelletized or crushed into powder and then injection molded, or compression molded into plastic parts of higher thicknesses. The extrusion, injection or compression temperature is typically within the range used in the melt-processing and compounding of the resins and ingredients.

The invention generally requires further processing with one or more manufacturing techniques to showcase its long term durability such as the elimination of retrogradation by the determination and analysis of its mechanical properties. The manufacturing methods of the TPS sheets may be achieved using mixing and melt-compounding equipment with adjustable and controllable temperatures and mixing speeds, such as a single cast film extruder or compression molding machine.

In certain embodiments, 100 g to about 150 g of already produced room temperature TPS from the above mentioned process is further compression molded into a mold with inside dimensions of 180 mm by 180 mm by 0.5 mm and at temperature and clamping pressures ranging from 100 to about 170° C. and 15 to about 30 kg/cm², respectively, for a period of 0.5 to about 3 minutes. The mold is cooled to room temperature before the sheets are extracted. The sheets are cut into 20 mm by 155 mm strips for mechanical properties analysis using a universal testing machine (UTM) according to ASTM methods.

Exemplary Embodiments of the Formulations of the Invention are illustrated in Table A.

TABLE A

| | | | Alkalizer | | |
|---|---|---|---|---|---|
| | (b) | (c) | (e.g., sodium | | |
| | Plasticizer | Acidifier | bicarbonate) | Water | |
| (a) | (e.g., | (e.g., | (% w/w) | phr based | |
| Starch | glycerol) | citric acid) | phr based on | on a, b, | Mineral |
| (% w/w) | (% w/w) | (% w/w) | a, b, and c | and c | (% w/w) |
| 60 | 18 | 22 | 3 | 5 | 0 |
| 35 | 20 | 10 | 2 | 10 | 35 |
| 52 | 30 | 18 | 6 | 5 | 0 |
| 65 | 20 | 5 | 5 | 10 | 10 |
| 45 | 40 | 15 | 4 | 8 | 0 |
| 60 | 22 | 18 | 10 | 5 | 0 |
| 42 | 40 | 18 | 6 | 10 | 0 |
| 50 | 40 | 10 | 8 | 15 | 0 |
| 55 | 15 | 10 | 6 | 5 | 20 |
| 20 | 25 | 5 | 3 | 10 | 50 |

phr = part per hundred

In certain embodiments, the biodegradable and compostable TPS composition exhibits a strain at break of 238%.

In certain embodiments, the biodegradable and compostable composition exhibits a stress at yield of 7.77 MPa.

In certain embodiments, the biodegradable and compostable composition exhibits a Young's Modulus of 470 MPa.

In certain embodiments, the biodegradable and compostable TPS composition exhibits a strain at break of 0.6%.

In certain embodiments, the biodegradable and compostable composition exhibits a stress at yield of 0.17 MPa.

In certain embodiments, the biodegradable and compostable composition exhibits a Young's Modulus of 0.14 MPa

In all embodiments, the biodegradable and compostable TPS compositions exhibit a bio-based carbon content of up to 100%.

In certain embodiments, the composition exhibits 10%, 20%, 30%, 40%, 50%, 60%, 70%, 80%, or 90% disintegration completion within about 180 to about 365 days at ambient temperature.

In certain embodiments, the composition exhibits 10%, 20%, 30%, 40%, 50%, 60%, 70%, 80%, or 90% disintegration completion within about 180 to about 365 days in soil at ambient temperature.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days.

In certain embodiments, the composition exhibits more than 90% biodegradation in less than 90, 100, 110, 120, 130, 140, 150, 160, 170, 175, or 180 days under thermophilic temperature conditions.

In all embodiments, the biodegradable compositions exhibit 32% disintegration within 45 days under mesophilic (home composting) conditions and 46% disintegration within 45 days under thermophilic (industrial conditions).

### EXAMPLES

Example 1: TPS was produced using a batch mixer or a kneader by compounding a premix of 940 grams of starch, 700 grams of a plasticizer and 360 grams of an acidifier. At this point, 120 and 200 grams of an alkalizer and water are added, respectively. The mixture is allowed to melt-blend for 5 mins at 175° C. At this point, the melt is extracted and allowed to cool to room temperature, bagged and stored away for further use. Sheets are also produced by compression molding 40 grams of the produced TPS composition at a clamping pressure, temperature and holding time of 30 kg/cm³, 150° C. and 120 secs, respectively. At this point, it was forced-cooled to room temperature before extraction. The sheets are cut into 20 mm by 155 mm strips for mechanical properties analysis using a UTM according to ASTM methods. The results are detailed in Table 1.

Example 2: TPS was produced using a batch mixer or a kneader by compounding a premix of 1040 grams of starch, 600 grams of a plasticizer, and 360 grams of an acidifier. At this point, 120 and 200 grams of an alkalizer and water are added, respectively. The mixture is allowed to melt-blend for 5 mins at 175° C. At this point, the melt is extracted and allowed to cool to room temperature, bagged and stored away for further use. Sheets are produced by compression molding 40 grams of the produced TPS composition at a clamping pressure, temperature and holding time of 30 kg/cm³, 150° C. and 120 secs, respectively. At this point, it was forced-cooled to room temperature before extraction. The sheets are cut into 20 mm by 155 mm strips for mechanical properties analysis using a UTM according to ASTM methods. The results are detailed in Table 1.

Example 3: TPS was produced using a batch mixer or a kneader by compounding a premix of 840 grams of starch, 360 grams of an acidifier, and 800 grams of a plasticizer. At this point, 120 and 200 grams of an alkalizer and water are added, respectively. The mixture is allowed to melt-blend for 5 mins at 175° C. At this point, the melt is extracted and allowed to cool to room temperature, bagged and stored away for further use. Sheets are produced by compression molding 40 grams of the produced TPS composition at a clamping pressure, temperature and holding time of 30 kg/cm³, 150° C. and 120 secs, respectively. At this point, it was forced-cooled to room temperature before extraction. The sheets are cut into 20 mm by 155 mm strips for mechanical properties analysis using a UTM according to ASTM methods. The results are detailed in Table 1.

Example 4: TPS was produced using a batch mixer or a kneader by compounding a premix of 1240 grams of starch, 360 grams of an acidifier, and 400 grams of a plasticizer. At this point, 120 and 200 grams of an alkalizer and water are added, respectively. The mixture is allowed to melt-blend for 5 mins at 175° C. At this point, the melt is extracted and allowed to cool to room temperature, bagged and stored away for further use. Sheets are produced by compression molding 40 grams of the produced TPS composition at a clamping pressure, temperature and holding time of 30 kg/cm³, 150° C. and 120 secs, respectively. At this point, it was forced-cooled to room temperature before extraction. The sheets are cut into 20 mm by 155 mm strips for mechanical properties analysis using a UTM according to ASTM methods. The results are detailed in Table 1.

TABLE 1
Mechanical properties of TPS formulations

| Properties | Example 1 | Example 2 | Example 3 | Example 4 |
|---|---|---|---|---|
| Thickness - mm | 3 | 3.18 | 3.15 | 5.01 |
| Stress at Yield | 0.07 | 0.09 | 0.22 | 1.97 |
| (MPa) | | | | |
| Strain at Break | 747 | 1246 | 210 | 86 |
| (%) | | | | |
| Young's Modulus | 0.99 | 0.27 | 0.19 | 2 |
| (MPa) | | | | |
| Moisture Content | <0.5 | <0.5 | <0.3 | <0.3 |
| (%) | | | | |

### Test Method for Long-Term Processability of Thermoplastic Starch

The long-term reprocessability of the TPS of the invention can be measured by producing TPS using the abovementioned production process. The TPS is allowed to cool then collected, divided into 11 lumps of approximately 20 g, bagged and stored over a period of 10 weeks. Using a compression molding machine, the lumps are compression molded into 20 g sheets over a period of 10 weeks at weekly intervals, starting with the compression molding of the first lump at the time of its production. The compression molding is performed at 150° C. and at clamping pressures ranging from 15 to about 30 kg/cm2.

Example 5: TPS is produced using a batch mixer or a kneader by compounding a premix of 840 grams of starch, 800 grams of a plasticizer and 360 grams of an acidifier. At this point, 120 and 200 grams of an alkalizer and water are added, respectively. The mixture is allowed to melt-blend for 15 mins at 180° C. At this point, the melt is extracted and allowed to cool to room temperature, bagged and stored away for further use.

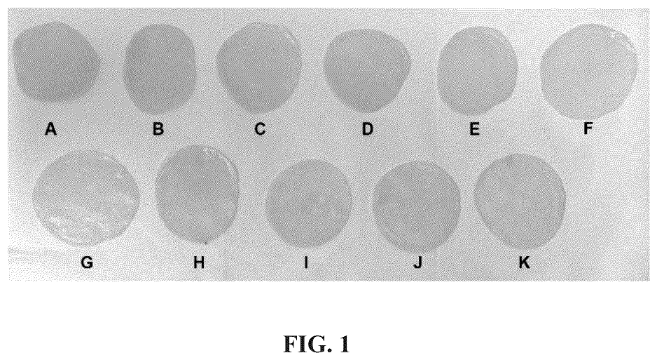

FIG. 1 shows sheets of the biodegradable and compostable TPS composition of the invention showcasing the long-term processability and elimination of retrogradation of Example 5, after being compression molded at intervals, over an extended period of ten weeks. There is no loss to retrogradation and there maintains its durability (i.e. flexibility, toughness, malleability and long-term processability). At each interval, the moisture content of the lump was determined and found to be in the range of 0.3 and 0.5 wt. % and remained mostly stable across the 10 week period.

### Test Method for Long-Term Mechanical Integrity

The long-term integrity of the TPS of the invention is crucial as it is well known that innate hygroscopic behavior and retrogradation can significantly affect its physical integrity. This attribute can be evaluated by producing TPS using the abovementioned production process. The TPS is allowed to cool then divided into lumps of 50 g each. The lumps are compression molded into sheets using a compression molding machine at 150° C. and at a clamping pressure of 50 kg/cm² for 5 seconds then cooled to room temperature. The sheets are cut into 20 mm by 155 mm strips for mechanical properties analysis using a UTM according to ASTM methods.

Example 6: TPS is produced using a batch mixer or a kneader by compounding a premix of 840 grams of starch, 800 grams of a plasticizer and 360 grams of an acidifier. At this point, 120 and 200 grams of an alkalizer and water are added, respectively. The mixture is allowed to melt-blend for 15 mins at 180° C. At this point, the melt is extracted and allowed to cool to room temperature, bagged and stored away for further use.

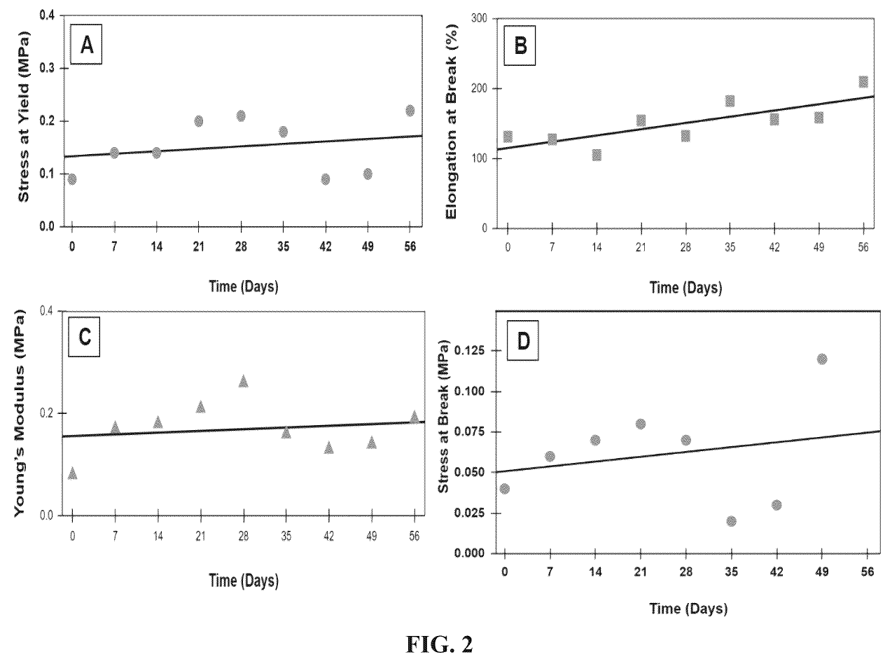

FIG. 2 shows a graphical representation of the mechanical properties of strips from Example 6, exposed to an average relative humidity of 30% and at room temperature, tested weekly, over a 9 week period. The trendline shows little to no inclination over the 9 week period, indicating that retrogradation is extremely slow or not occurring at all, which will typically cause the TPS to lose its elastomeric behavior over time, hence, a loss in elongation, gain in modulus and strength. Likewise, the trend lines show minimal inclination in the elongation at break over the 9-week period, indicating mitigation of the innate hygroscopic nature of TPS as also observed from the moisture content of <0.5% over the 9-week period.

### Test Method for Multi-Recyclability of Thermoplastic Starch

The recyclability of the TPS of the invention can be evaluated by producing TPS using the abovementioned production process. The TPS is allowed to cool then divided into 10 lumps of approximately 50 g each. The lumps are compression molded using a compression molding machine typically from a range of 150 to about 175° C. and at a clamping pressure from a range of about 30 to about 50 kg/cm² for a duration from about 5 to 120 seconds then cooled to room temperature. This process was repeated once for one lump, twice for another, thrice for another, four times for another, five times for yet another and up to ten times to the tenth lump. This was done to mimic recyclability of biopolymers when put through a melt processing equipment by imparting repeated thermal and shear to the TPS over time. Each recycled TPS sheet, up to ten times, is then melt-blended with polylactic acid (PLA) at a weight ratio of 70 wt. % PLA to 30 wt. % using a micro compounding machine with a mini-injector unit. The aforementioned processes may be achieved using other processing methods and equipment such as a mixing and melt-compounding equipment with adjustable and controllable temperatures and mixing speeds, such as a single or twin screw extruder or a batch kneader to achieve the recyclability of the TPS and production of the PLA/TPS blend resin thereafter. In a batch kneader, the processing temperature profile may range from 50 to 200° C., and the processing time may be between about 1 to about 15 minutes. Alternatively, in scenarios where single or twin-screw extrusion is employed, the temperature profile may range from about 50 to about 200° C., and the screw speed may range from about 50 to about 500 rpm. It should be noted that the processing conditions provided herein are not limiting and may vary based on other conditions such as ingredient ratios and processing equipment. Cast film extrusion and compression molding can be used to produce films from the blend resin for mechanical testing and analysis.

In all embodiments, the biodegradable and compostable PLA/TPS resin compositions exhibit a bio-based carbon content of up to 100%.

In certain embodiments, the PLA/TPS resin composition exhibits a strain at break of 10%.

In certain embodiments, the PLA/TPS resin composition exhibits a stress at yield of 39 MPa.

In certain embodiments, the PLA/TPS resin composition exhibits a modulus of 2555 MPa.

In all embodiments, the biodegradable and compostable PLA/TPS resin compositions did not exhibit any thermal degradation during the processing.

In all embodiments, the biodegradable and compostable PLA/TPS resin compositions enhanced the plasticization of the PLA biopolymer.

Example 7: TPS is produced using a batch mixer or a kneader by compounding a premix of 840 grams of starch, 800 grams of a plasticizer and 360 grams of an acidifier. At this point, 120 and 200 grams of an alkalizer and water are added, respectively. The mixture is allowed to melt-blend for 15 mins at 180° C. At this point, the melt is extracted and allowed to cool to room temperature, bagged and stored away for recycling using the compression molding techniques as explained above and then further use during melt-blending with PLA.

Approximately 12 g of the PLA/TPS 70/30 (w/w) premix is charged into a micro compounder and allowed to mix for 60 seconds at a screw speed of 100 rpm and processing temperature of 185° C. before it is collected and injection molded into tensile test bars for mechanical evaluation using ASTM standards. The tensile bars were injection molded at pressures of 10 bars and using a mold at room temperature.

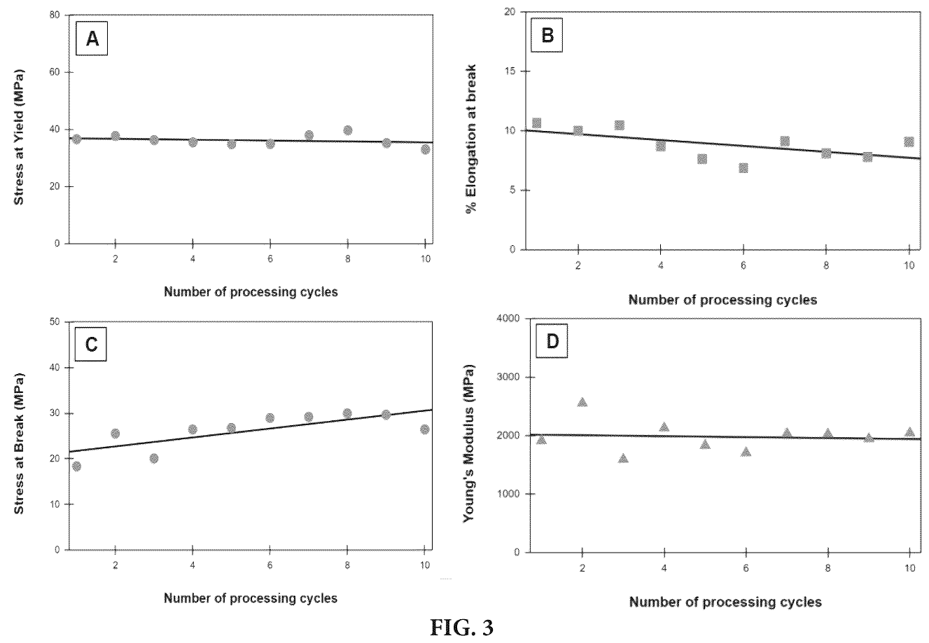

FIG. 3 shows the mechanical properties of PLA/TPS blend resin composition, comprising recycled TPS over 10 cycles. It can be observed that the TPS is very stable over 10 recycling processes of compression molding at an elevated temperature of 150° C. and for 120 seconds. The trendlines show little to no inclination or declination of the mechanical properties of the blend resin, indicating that the TPS does not deteriorate (degrade and retrograde) over prolonged and multiple exposure to stresses involved during processing such as thermal and shear stresses.

In the following 3 examples, the starch-based additive ingredients were premixed in a container and then mixed thoroughly using a mechanical mixer. 840 grams of starch, 800 grams of a plasticizer and 360 grams of an acidifier were uniformly mixed followed by the addition of 120 and 200 grams of an alkalizer and water, respectively. The mixture was blended under to a homogeneously consistency for 5 mins and then bagged and stored away for further use.

Example 8: A micro-compounder was pre-heated to 180° C. before adding 80 and 20 wt. % of PBAT and the abovementioned starch-based additive, respectively. The ingredients were allowed to compound for 2 minutes under a screw speed of 100 rpm until a uniform melt was formed. The melt was then collected in a cylinder-piston melt transfer device preheated at 180° C. and injected into notched Izod impact and tensile bars with the molds at room temperature using an injection pressure of 9 bars and a holding period of 15 seconds.

The mechanical properties of the injected bars were then evaluated using a universal testing machine (UTM) according to ASTM methods and were compared with neat PBAT. The results are shown in Table 2.

Example 9: A micro-compounder was pre-heated to 180° C. before adding 80 and 20 wt. % of PBS and the abovementioned starch-based additive, respectively. The ingredients were allowed to compound for 2 minutes under a screw speed of 100 rpm until a uniform melt was formed. The melt was then collected in a cylinder-piston melt transfer device preheated at 180° C. and injected into notched Izod impact and tensile bars with the molds at room temperature using an injection pressure of 9 bars and a holding period of 15 seconds.

The mechanical properties of the injected bars were then evaluated using a UTM according to ASTM methods and were compared with neat PBS. The results are shown in Table 2.

Example 10: A micro-compounder was pre-heated to 180° C. before adding 60 and 40 wt. % of PLA and the abovementioned starch-based additive, respectively. The ingredients were allowed to compound for 2 minutes under a screw speed of 100 rpm until a uniform melt was formed. The melt was then collected in a cylinder-piston melt transfer device preheated at 180° C. and injected into notched Izod impact and tensile bars with the molds at room temperature using an injection pressure of 9 bars and a holding period of 15 seconds.

The mechanical properties of the injected bars were then evaluated using a UTM according to ASTM methods and were compared with neat PLA. The results are shown in Table 2.

Example 11: In this example, the starch-based additive was produced in a plastic container with the ingredients mixed thoroughly using a mechanical mixer. 1100 grams of starch, 260 grams of a plasticizer and 360 grams of an acidifier were uniformly mixed followed by the addition of 120 and 200 grams of an alkalizer and water, respectively. The mixture was allowed to blend homogeneously for 5 mins and then it was bagged and stored away for further use. A micro-compounder was pre-heated to 180° C. before adding 25 wt. % PLA and 75 wt. % starch-based additives. The ingredients were allowed to compound for 2 minutes under a screw speed of 100 rpm until a uniform melt was formed. The melt was then collected in a cylinder-piston melt transfer device preheated at 180° C. and injected into notched Izod impact and tensile bars with the molds at room temperature using an injection pressure of 9 bars and a holding period of 15 seconds.

The mechanical properties of the injected bars were then evaluated using a UTM according to ASTM methods, the results are shown in Table 2.

TABLE 2
Mechanical properties of the blend compositions

| | Example | Neat | Example | Neat | Example | Neat | Example |
|---|---|---|---|---|---|---|---|
| Property | 8 | PBAT | 9 | PBS | 10 | PLA | 11 |
| Stress at | 7.1 | 8.4 | 28.4 | 36 | 28.2 | 75.3 | 15.5 |
| Yield | | | | | | | |
| (MPa) | | | | | | | |
| Stress at | 19.5 | 22.1 | 27.2 | 27.6 | 21.6 | 75.3 | 11.8 |
| Break | | | | | | | |
| (MPa) | | | | | | | |
| Young's | 78 | 99.3 | 417 | 506.7 | 1672 | 3679.7 | 528 |
| Modulus | | | | | | | |
| (MPa) | | | | | | | |
| Strain at | 22.3 | 18.5 | 14.5 | 10.9 | 1.95 | 2.6 | 4.1 |
| Yield (%) | | | | | | | |
| Strain at | 475 | 414.5 | 321.6 | 230.3 | 8.5 | 2.6 | 85.7 |
| Break (%) | | | | | | | |
| Notched | None | None | 59.8 | 97.4 | 80 | 37.6 | 11 |
| Izod | Break | Break | | | | | |
| Impact | | | | | | | |
| (J/m) | | | | | | | |

Example 12: In this example, the starch-based additive was produced in a plastic container with the ingredients mixed thoroughly using a mechanical mixer along with the biodegradable polyester. 2000 grams of PLA, 1400 grams of starch, 1200 grams of a plasticizer and 540 grams of an acidifier were uniformly mixed followed by the addition of 180 and 300 grams of an alkalizer and water, respectively. The mixture was premixed homogeneously for 5 mins before feeding into a twin-screw extruder. The feeding rate was about 10 kg per hour. The extruder barrel temperature profile was set at 50° C. in the first zone, rising to 170° C. in the kneading zones, then reduced to 140° C. at the die. The strand extrudates were cooled and transferred to a pelletizer, using a cooling fan-assisted conveyor machine, and were pelletized and stored in closed, airtight bags for further processing. The pellets of the produced biodegradable blend resin were then injected into notched Izod impact and tensile bars with the molds at room temperature using an injection molding machine with a barrel preheated at 140-165° C. from the feeding zone to the nozzle, a screw speed of 50 rpm, an injection pressure of 0.8 MPa and a cooling time of 10 seconds. The mechanical properties of the injected bars were then evaluated using a UTM according to ASTM methods. The produced biodegradable blend exhibited a stress at yield of 29 MPa, an elongation at break of 7.6%, a Young's modulus of 1760 MPa and a notched Izod impact strength of 26 J/m whereas the measured values for the neat PLA were 71 MPa, 2.6%, 3450 MPa and 26 J/m, respectively.

Example 13: In this example, the starch-based additive was produced in a plastic container with the ingredients mixed thoroughly using a mechanical mixer along with the biodegradable polyester. 3000 grams of PBS, 933 grams of starch, 800 grams of a plasticizer and 360 grams of an acidifier were uniformly mixed followed by the addition of 120 and 200 grams of an alkalizer and water, respectively. The mixture was premixed homogeneously for 5 mins before feeding into a twin-screw extruder. The feeding rate was about 10 kg per hour. The extruder barrel temperature profile was set at 50° C. in the first zone, rising to 170° C. in the kneading zones, then reduced to 140° C. at the die. The strand extrudates were cooled and transferred to a pelletizer, using a cooling fan-assisted conveyor machine, and were pelletized and stored in closed, airtight bags for further processing. The pellets of the produced biodegradable blend resin were then extruded into a film using a cast film extruder with a barrel preheated at 100-150° C. from the feeding zone to the die, a screw speed of 30 rpm. The extruded film was cast on a chilled roller at a temperature of 15-20° C. and passed through a set of guiding rollers to a winding roller where a roll of the extruded film was collected. The chilled roller speed and the winding roller speed were adjusted to yield a film of 220-290 microns. The produced film was then cut into ribbons for mechanical testing in both machine direction (MD) and transverse direction (TD) using a UTM according to ASTM standards. The produced biodegradable blend exhibited a stress at yield of 8.8/8.0 MPa (MD/TD), an elongation at break of 16.5/16.2% (MD/TD), and a Young's modulus of 160/150 MPa (MD/TD) whereas the measured values for the neat PBS were 22/22 MPa (MD/TD), 28/13% (MD/TD), and 630/610 MPa (MD/TD), respectively.

In all of the following examples, the TPS was produced using a batch mixer or a kneader by compounding a premix of 840 grams of starch, 360 grams of an acidifier, and 800 grams of a plasticizer. At this point, 120 and 200 grams of an alkalizer and water are added, respectively. The mixture is allowed to melt-blend for 5 mins at 175° C. At this point, the melt is extracted and allowed to cool to room temperature, bagged and stored away for further use.

Example 14: A micro-compounder was pre-heated to 180° C. before adding 60 and 40 wt. % of PBS and TPS, respectively. The polymers were allowed to compound for 2 minutes under a screw speed of 100 rpm until a uniform melt was formed. The melt was then collected using a cylinder-piston device preheated at 180° C. and injected into notched Izod impact and tensile molds at room temperature with a pressure of 9 bars and a holding period of 15 seconds.

The mechanical properties of the injected bars were then evaluated using a UTM according to ASTM methods, the results are shown in Table 3.

Example 15: A micro-compounder was pre-heated to 180° C. before adding 60 and 20 wt. % of PLA and TPS, respectively. The polymers were allowed to compound for 1.5 minutes under a screw speed of 100 rpm until a uniform melt was formed. The melt was then collected using a cylinder-piston device preheated at 180° C. and injected into notched Izod impact and tensile molds at room temperature with a pressure of 9 bars and a holding period of 10 seconds.

The mechanical properties of the injected bars were then evaluated using a UTM according to ASTM methods, the results are shown in Table 3.

Example 16: A micro-compounder was pre-heated to 180° C. before adding 60 and 40 wt. % of PBAT and TPS, respectively. The polymers were allowed to compound for 2 minutes under a screw speed of 100 rpm until a uniform melt was formed. The melt was then collected using a cylinder-piston device preheated at 180° C. and injected into notched Izod impact and tensile molds at room temperature with a pressure of 9 bars and a holding period of 15 seconds.

The mechanical properties of the injected bars were then evaluated using a UTM according to ASTM methods, the results are shown in Table 3.

Example 17: A micro-compounder was pre-heated to 180° C. before adding 19.2, 57.7 and 23.1 wt. % of PLA, TPS and talc, respectively. The polymers were allowed to compound for 2 minutes under a screw speed of 100 rpm until a uniform melt was formed. The melt was then collected using a cylinder-piston device preheated at 180° C. and injected into notched Izod impact and tensile molds at room temperature with a pressure of 15 bars and a holding period of 15 seconds.

The mechanical properties of the injected bars were then evaluated using a UTM according to ASTM methods, the results are shown in Table 3.

Example 18: A micro-compounder was pre-heated to 180° C. before adding 75 and 25 wt. % of PBAT and TPS, respectively. The polymers were allowed to compound for 2 minutes under a screw speed of 100 rpm until a uniform melt was formed. The melt was then collected using a cylinder-piston device preheated at 180° C. and injected into notched Izod impact and tensile molds at room temperature with a pressure of 15 bars and a holding period of 15 seconds.

The mechanical properties of the injected bars were then evaluated using a UTM according to ASTM methods, the results are shown in Table 3.

TABLE 3
Mechanical properties of the blend compositions

| Property | Example 14 | Example 15 | Example 16 | Example 17 | Example 18 |
|---|---|---|---|---|---|
| Stress at Yield | 19.9 | 45.48 | 4.52 | 2.19 | 0.52 |
| (MPa) | | | | | |
| Stress at Break | 21.93 | 20.53 | 6.34 | 1.46 | 0.22 |
| (MPa) | | | | | |
| Young's | 275.12 | 3042.2 | 41.9 | 32.21 | 1.05 |
| Modulus | | | | | |
| (MPa) | | | | | |
| Strain at Yield | 12.79 | 2.18 | 26.68 | 19.4 | 111.22 |
| (%) | | | | | |
| Strain at Break | 338.6 | 7.82 | 789.24 | 47.47 | 526.41 |
| (%) | | | | | |
| Notched Izod | 121.13 | 66.47 | None break | 123.86 | None break |
| Impact (J/m) | | | | | |

While the present invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A starch-based additive composition comprising of:
[a] about 20 to about 90% (w/w) of one or more biodegradable and compostable starch or modified starch;
[b] about 5 to about 60% (w/w) of one or more of plasticizers;
[c] about 0.2 to about 40% (w/w) of one or more acidifiers;
[d] about 0.1 to about 15 parts per hundred resin (phr), with respect to [a], [b] and [c], of one or more of alkalizers;
[e] a minimum of 5 parts per hundred resin (phr), with respect to [a], [b] and [c], of water;
[f] about 0 to about 20% (w/w) of one or more of additives comprising coupling agents, chain extenders, biomass, minerals, initiators, compatibilizer, peroxides, impact modifiers and pigments.

2. A biodegradable blend composition comprising:
about 5 to 90% (w/w) of one or more biodegradable thermoplastic polyester; and
about 5 to 95% (w/w) of the starch-based additive composition of claim 1.

3. The starch-based additive composition of claim 1, wherein the composition is gelatinized into thermoplastic starch (TPS) in presence of heat and shear using techniques comprising extrusion and batch mixing.

4. The starch-based additive composition of claim 1, wherein the composition exhibits a bio-based carbon content of 100%.

5. The starch-based additive compositions of claim 1, wherein the starch is one or more of starch, in the form of native or modified starch, comprising:
a. cereal grains selected from the group comprising corn of all types, wheat, sorghum, nice, and waxy rice, which can also be used in the flour and cracked state,
b. tubers of all types and nature selected from the group comprising potato, sweet potato, yam, roots (tapioca from cassava and manioc and arrowroot),
c. plant stems and barks selected from the group comprising pith of the sago palm,
d. fruits of all types,
e. other starchy plant parts, and
f. combinations thereof.

6. The starch-based additive compositions of claim 1, wherein the plasticizers comprise one or more of polyols, plant-based oils or a combination thereof which are either in their virgin or modified form.

7. The starch-based additive compositions of claim 1, wherein the plasticizers comprise one or more plant-based oils obtained from vegetables, nuts, grains, seeds, wherein the oil is
a. one or more virgin oils selected from the group consisting of corn oil, soybean oil, linseed oil, canola oil, peanut oil, palm oil, cashew oil, cottonseed oil, rapeseed oil, olive oil; or
b. one or more modified oils, modified through different methods selected from the group consisting of epoxidation, carboxylation, hydroxylation and amidation; or
c. one or more modified oils, modified with long and/or short-chain hydrocarbons with functional groups selected from the group consisting of epoxides, hydroxyls, anhydrides, 2,5-Dimethyl-2,5-di(tert-butylperoxy) hexane, citrates; or
d. a combination thereof.

8. The starch-based additive compositions of claim 1, wherein the plasticizers comprise one or more polyols selected from the group consisting of sorbitol, lactitol, maltitol, mannitol, galactitol, xylitol, glycerol, ribitol, arabitol, erythritol, threitol, and a combination thereof.

9. The starch-based additive compositions of claim 1, wherein the acidifiers are selected from the group consisting of agaric acid, potassium citrate, propane-1,2,3-tricarboxylic acid, aconitic acid, citric acid, tartaric acid, isocitric acid, sodium lactate, trimesic acid, calcium acetate, and combinations thereof.

10. The starch-based additive compositions of claim 1, wherein the alkalizer comprises calcium carbonate, sodium bicarbonate, potassium citrate, sodium lactate, calcium acetate, and combinations thereof.

11. The starch-based additive compositions of claim 1, wherein the composition exhibits a 90% disintegration completion within about 180 to about 365 days in soil at ambient temperature.

12. The biodegradable blend composition of claim 2, where the biodegradable thermoplastic polyester is one or more of polymers selected from the group consisting of polylactic acid, polycaprolactone, polybutylene succinate, polybutylene succinate adipate, polybutylene succinate terephthalate, polybutylene adipate-co-terephthalate, polyhydroxyalkanoates and combinations thereof.

13. The biodegradable blend composition of claim 2, further comprising a plasticizer that is a plant-based oil selected from the group consisting of vegetables, nuts, grains, seeds, or combinations thereof, wherein the oils comprise corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

14. The biodegradable blend composition of claim 2, further comprising an inorganic filler selected from the group consisting of wollastonite, mica, clay, calcium carbonate, glass fiber, talc, aluminum silicate, zirconium oxide, sepiolite, gypsum and a combination thereof.

15. The biodegradable blend composition of claim 2, further comprising a biomass selected from distillers' grains, vinasse, vinegar residues, wood fiber, virgin starch, modified starch (including thermoplastic starch), agricultural cellulosic matter, straw, stalk, shive, hurd, bast, leaf, seed, fruit, and perennial grass, all in a non-continuous nonwoven form, which may consist of chopped pieces, particulates, dust, or flour.

16. The biodegradable blend composition of claim 2, wherein the bio-based carbon content of the composition is up to 100%.

17. The biodegradable blend composition of claim 2, wherein the composition exhibits a 90% disintegration completion within about 180 to about 365 days in soil at ambient temperature.

18. The biodegradable blend composition of claim 2, wherein the blends show an elongation at break of at least 8.5%, a stress at break of at least 21.5 MPa, and a notched Izod impact strength of at least 80 J/m.

19. The thermoplastic starch (TPS) of claim 3, wherein the TPS exhibits no retrogradation over time.

20. The thermoplastic starch (TPS) of claim 3, wherein the TPS exhibits: (i) thermal stability of less than a 9 wt. % mass loss at a temperature of 200° C., tested in air and at a heating rate of 20° C./min using a thermogravimetric analyzer (TGA); (ii) a thermal degradation onset temperature of more than 140° C., tested in air and at a heating rate of 20° C./min using a thermogravimetric analyzer (TGA); (iii) long-term durability as indicated by the less than 10% changes to mechanical properties comprising tensile strength, elongation and modulus over a period of at least 12 months, or (iv) more than 90% disintegration in less than 84 days and more than 90% biodegradation in less than 180 days under ASTM D6400, and under thermophilic temperature conditions
